(19) United States
(12) Patent Application Publication
(10) Pub. No.: US 2001/0029832 A1
(43) Pub. Date: Oct. 18, 2001

(54) Information processing device, information processing method, and recording medium

(76) Inventors: Takeshi Kanda, Tokyo (JP); Makoto Ishii, Kanagawa (JP); Takao Sasamura, Kanagawa (JP); Riyo Tonomoto, Tokyo (JP)

Correspondence Address: William S. Frommer, Esq., FROMMER LAWRENCE & HAUG LLP, 745 FIFTH AVENUE, NEW YORK, NY, 10151, US

(21) Appl. No.: 09/782,210

(22) Filed: Feb. 13, 2001

(30) Foreign Application Priority Data
Feb. 15, 2000 (JP) 2000-036403

(51) Int. Cl. G10H 1/26

(52) U.S. Cl. 84/609

(57) ABSTRACT

With music data made up of four instrument/vocal parts of, e.g., a piano, base, drums, and vocals, project data handled by a management center is configured of tracks with each part existing independently. Tracks 1 through 4 each have independent copyright information, which is to say that even in the event that the tracks 1 through 4 are each created by different creators, copyright information is recorded to each of the tracks 1 through 4, and even in the event that a track for a new part is added to the project data for example, thereby generating different project data, the copyright information on each track is not deleted. Thus, music data made up of multiple tracks having copyright information on each track can be distributed.

### BACKGROUND OF THE INVENTION

1. Field of the Invention

The present invention relates to an information processing device, information processing method, and recording medium, and particularly relates to an information processing device, information processing method, and recording medium suitably used for distributing music data via networks such as the Internet.

2. Description of the Related Art

Conventionally, music distribution has mainly been performed using a method called mixing down (also referred to as “track-down”) audio data made up of multiple individually-recorded tracks into stereo (i.e., into two channels), and storing this in recording mediums such as records or CDS for sale. Normally, general listeners listen to music using media such as CDs, cassette tapes, records, or other such media. Currently, all of these are recorded with 4 to 48 or more tracks which have been edited and mixed down to two tracks (i.e., two-channel stereo).

Now, recently, a new type of music distribution method has started to take hold as a business for distributing music data to consumers, wherein, unlike music distribution where the music tracks are recorded on a recording medium, the music data made up of stereo digital audio data is subjected to encoding (compressing and encoding), placed on a server connected to the Internet, users download desired music data via the Internet, and decode (decompress and decode) the data which then can be played.

Specifically, distribution service providers for distributing music data receive music pieces which music production companies have produced, compress this using compression methods such as MP3 (MPEG1 Audio Layer III), AAC (Advanced Audio Coding), or ATRAC3 (Adaptive Transform Acoustic Coding), and the like, and stored the compressed music data in a distributing server. The user connects to a Web site of a distribution service provider, downloads desired music piece data via the Internet, stores the music prices in the computer of the user or in other information processing devices, or in a recording medium mounted thereto. The user pays a fee of around several hundred Yen per piece, for example, to the distribution service provider.

In the event of creating a music piece made up from drums, a base, a guitar, and a vocal, for example, first, the drum, base, and guitar players, and the vocalist are called in to a recording studio, and the drum part played by the drummer, the base part played by the basist, the guitar part played by the guitarist, and the vocal part sung by the vocalist, are each recorded using a digital audio recorder. The music piece producer plays the audio tracks for the four recorded parts from the digital audio recorder, and mixes these into two tracks of data while adjusting the level of each part. Conventionally, music data distributed via the Internet has also been music data mixed down into stereo signals, in the same manner as music data recorded on CDs (Compact Disks) and MDs (Mini Disks) and sold in stores.

However, these currently-proposed music piece data distribution systems using the Internet have been developed dwelling only the aspect of users listening to downloaded music piece data. It might be the that users who are satisfied with nothing more than listening to distributed music piece data perhaps will be satisfied with the currently-proposed systems.

However, there are new requests arising from users who deal with lyrics writing, music writing, editing, performing, etc., i.e., the creating of music, to not only listen to the post-mix completed music, but also to be able to extract particular parts from the multiple parts making up the music piece and listen to those parts only, or edit the parts, or further add new parts, all of which cannot be realized with music data that has been mixed down, since the process of mixing down renders the parts thereof non-editable.

For example, with a music piece data made up from drums, a base, a piano, and a vocalist, there have been requests that the pianist, for example, might want to extract only the piano part contained in the music piece data and listen to or edit this music piece data for that part alone. However, as described above, it is impossible to extract only the piano part music data from music data that has already been mixed down.

Also, with the above-described conventional music creating activities, each of the musicians have to go to a studio to play. Normally, it is rather unusual that multiple musicians can gather at a recording studio all at one time to record, so each part is recorded separately by each musician, and following recording of each of the parts, the music piece producer mixes down all the tracks to complete the music piece. In some instances, one part may not match well with other parts, requiring the players and music piece producer to travel to the recording studio numerous times.

That is to say, with music piece creating activities in conventional recording studios, there is loss timewise since the players and music piece producer have to adjust schedules and actually travel to the studio, which has impended speedy music piece creation.

### SUMMARY OF THE INVENTION

The present invention has been made in light of such, and accordingly, it is an object thereof to provide a system wherein music piece data having copyright information is registered in a management center which performs services such as distribution, distribution via networks such as the Internet is enabled, and copyright protection and charges for each piece of music data thereof is also enabled.

To this end, according to a first aspect of the present invention, an information processing device comprises: holding means for holding music data made up of a plurality of tracks; adding means for adding copyright information to each of the tracks; information setting control means for controlling the setting of necessary information, for registering with another information processing device capable of distributing by individual track the music data made up of a plurality of tracks to which are added copyright information by the adding means; and transmission control means for controlling transmission via a network, of the music data made up of a plurality of tracks to which are added copyright information by the adding means and the information set by the information setting control means.

According to a second aspect of the present invention, an information processing method comprises: a holding step for holding music data made up of a plurality of tracks; an adding step for adding copyright information to each of the tracks; an information setting control step for controlling the setting of necessary information, for registering with another information processing device capable of distributing by individual track the music data made up of a plurality of tracks to which are added copyright information by the processing in the adding step; and a transmission control step for controlling transmission via a network, of the music data made up of a plurality of tracks to which are added copyright information in the adding step and the information set by the processing in the information setting control step.

According to a third aspect of the present invention, an information processing device comprises: holding means for holding music data made up of a plurality of tracks; adding means for adding copyright information to each of the tracks; information setting control means for controlling the setting of necessary information, for registering with another information processing device capable of distributing by individual track the music data made up of a plurality of tracks to which are added copyright information by the adding means, the other information processing device controlled so that only predetermined users verified beforehand can perform registering and distribution of the music data; and transmission control means for controlling transmission via a network, of the music data made up of a plurality of tracks to which are added copyright information by the adding means and the information set by the information setting control means.

According to a fourth aspect of the present invention, an information processing method comprises: a holding step for holding music data made up of a plurality of tracks; an adding step for adding copyright information to each of the tracks; an information setting control step for controlling the setting of necessary information, for registering with another information processing device capable of distributing by individual track the music data made up of a plurality of tracks to which are added copyright information by the processing in the adding step, the other information processing device controlled so that only predetermined users verified beforehand can perform registering and distribution of the music data; and a transmission control step for controlling transmission via a network, of the music data made up of a plurality of tracks to which are added copyright information by the processing in the adding step and the information set by the processing in the information setting control step.

According to a fifth aspect of the present invention, an information processing device comprises: reception control means for controlling reception of contents data transmitted via a network and copyright information set to the contents data; encoding processing means for performing encoding processing of the contents data regarding which reception has been controlled by the reception control means; saving control means for controlling saving of the contents data subjected to encoding processing by the encoding processing means; and calculating means for calculating copyright usage fees for the contents data, based on the copyright information.

The contents data may be music data, made up of a plurality of tracks, and copyright information may be set for each of the plurality of tracks.

According to a sixth aspect of the present invention, an information processing method comprises: a reception control step for controlling reception of contents data transmitted via a network and copyright information set to the contents data; an encoding processing step for performing encoding processing of the contents data regarding which reception has been controlled in the reception control step; a saving control step for controlling saving of the contents data subjected to encoding processing in the encoding processing step; and a calculating step for calculating copyright usage fees for the contents data, based on the copyright information.

According to a seventh aspect of the present invention, an information processing device comprises: reception control means for controlling reception of contents data transmitted via a network and copyright information set to the contents data; and calculating means for calculating billing fees at the time of using the contents data, based on the copyright information.

The information processing device may further comprise encoding processing means for performing encoding processing of the contents data regarding which reception has been controlled by the reception control means, and saving control means for controlling saving of the contents data subjected to encoding processing by the encoding processing means. The contents data may be music data, made up of a plurality of tracks, and copyright information may be set for each of the plurality of tracks.

According to an eighth aspect of the present invention, an information processing method comprises: a reception control step for controlling reception of contents data transmitted via a network and copyright information set to the contents data; and a calculating step for calculating billing fees at the time of using the contents data, based on the copyright information.

With the information processing device and information processing method according to the first and second aspects, music data made up from multiple tracks is held, copyright information is added for each track, and music data made up from multiple tracks to which copyright information is added is registered to another information processing device capable of distributing the music data by individual tracks, so music data made up for multiple tracks to which copyright information has been added and information set by information setting control means is transmitted via a network. with the information processing device and information processing method according to the third and fourth aspects, music data made up from multiple tracks is held, copyright information is added for each track, and music data made up from multiple tracks to which copyright information is added is registered to another information processing device capable of distributing the music data by individual, the other information processing device being controlled so that only predetermined users verified beforehand can perform registering and distribution of the music data, so music data made up for multiple tracks to which copyright information has been added and information set by information setting control means is transmitted via a network.

With the information processing device and information processing method according to the fifth and sixth aspects, contents data transmitted via a network and copyright information set to the contents data is received, the contents data is subjected to encoding processing, the contents data subjected to encoding processing is saved, and copyright usage fees for the contents data are calculated based on the copyright information.

With the information processing device and information processing method according to the seventh and eighth aspects, contents data transmitted via a network and copyright information set to the contents data is received, and copyright usage fees for the contents data are calculated based on the copyright information.

Now, looking at some other aspects of the present invention, according to a ninth aspect of the present invention, an information processing device comprises: holding means for holding music data made up of a plurality of tracks; reception control means for controlling reception of signals representing transmission request for the music data from other information processing devices via a network; searching means for searching for the music data held by the holding means, based on the signals of which reception is controlled by the reception control means; and first transmission control means for controlling transmission of the music data searched by the searching means, by each of the plurality of the tracks.

Here, copyright information may be set to each of the plurality of tracks.

Also, the information processing device may further comprise: calculating means for calculating usage fees for the music data based on the copyright information; and second transmission control means for controlling transmission of data corresponding to the usage fees of the music data calculated by the calculating means, with regard to the other information processing device of which transmission of the music data has been controlled by the first transmission control means.

According to a tenth aspect of the present invention, an information processing method comprises: a holding control step for controlling the holding of music data made up of a plurality of tracks; a reception control step for controlling reception of signals representing transmission request for the music data from other information processing devices via a network; a searching step for searching for the music data held in the holding step, based on the signals of which reception is controlled by the processing in the reception control step; and a first transmission control step for controlling transmission of the music data searched by the processing in the searching step, by each of the plurality of the tracks.

According to an eleventh aspect of the present invention, a recording medium has recorded therein a computer-readable program comprising: a holding control step for controlling the holding of music data made up of a plurality of tracks; a reception control step for controlling reception of signals representing transmission request for the music data from other information processing devices via a network; a searching step for searching for the music data held by the processing in the holding step, based on the signals of which reception is controlled by the processing in the reception control step; and a first transmission control step for controlling transmission of the music data searched by the processing in the searching step, by each of the plurality of the tracks.

With the information processing device, information processing method, and program stored in the recording medium, according to the ninth through eleventh aspects, the holding of music data made up of multiple tracks is controlled, reception of signals representing transmission requests for the music data from other information processing devices via a network is controlled, the music data held by the processing in the holding step is searched for based on the signals of which reception is controlled, and the music data searched by the processing in the searching step is controlled by track.

According to a twelfth aspect of the present invention, an information processing device connected to other information processing devices via a network comprises: first providing means for a plurality of members to provide a virtual community for activities of cooperatively creating contents to the network; verifying means for performing verification processing of access rights to the community in the event that the information processing device is accessed by the other information processing devices via the network; and second providing means for providing services relating to activities of creating the contents to the other information processing devices via the network, based on the verification results of the verifying means.

Now, the second providing means may register contents provided from the plurality of members to the community, and the second providing means may provide the contents registered to the community to other members.

The second providing means may further register to the community contents created based on the contents registered to the community and provided from the plurality of members. Also, the first providing means may issue IDs to users of the other information processing devices, and the second providing means may register the contents in a manner corresponding to the IDs, so that the creators of the contents can be identified.

According to a thirteenth aspect of the present invention, an information processing method of an information processing device connected to other information processing devices via a network comprises: a first providing step for a plurality of members in a predetermined mutual relationship to provide a virtual community for activities of cooperatively creating contents to the network; a verifying step for performing verification processing of access rights to the community in the event that the information processing device is accessed by the other information processing devices via the network; and a second providing step for providing services relating to activities of creating the contents to the other information processing devices via the network, based on the verification results by the processing in the verifying step.

According to a fourteenth aspect of the present invention, an information processing device connected to other information processing devices via a network comprises: registering means for registering contents provided from a plurality of members to a virtual community for the plurality of members to perform activities of cooperatively creating contents; verifying means for performing verification processing of access rights to the community in the event that the information processing device is accessed by the other information processing devices via the network; and providing means for providing the contents registered to the community to the other information processing devices via the network, based on the verification results of the verifying means.

The providing means may further register to the community contents created by modifying or arranging the contents registered to the community and provided from the plurality of members, and the providing means may further provide to other information processing devices contents created by modifying or arranging the contents registered to the community and further registered to the community.

According to a fifteenth aspect of the present invention, an information processing method for an information processing device connected to other information processing devices via a network comprises: a registering step for registering contents provided from a plurality of members to a virtual community for the plurality of members to perform activities of cooperatively creating contents; a verifying step for performing verification processing of access rights to the community in the event that the information processing device is accessed by the other information processing devices via the network; and a providing step for providing the contents registered to the community to the other information processing devices via the network, based on the verification results by the processing in the verifying step.

With the information processing device and information processing method according to the twelfth and thirteenth aspects, multiple members in a predetermined mutual relationship provide a virtual community for activities of cooperatively creating contents to a network, access rights to the community are verified in the event that the information processing device is accessed by the other information processing devices via the network, and services relating to activities of creating the contents are provided to other information processing devices via the network, based on the verification results.

Also, with the information processing device and information processing method according to the fourteenth and fifteenth aspects, contents provided from multiple members are registered to a virtual community for the multiple members to perform activities of cooperatively creating contents, access rights to the community are verified in the event that the information processing device is accessed by the other information processing devices via the network, and the contents registered to the community are provided to other information processing devices via the network, based on the verification results.

According to another aspect of the present invention, a music piece distributing system comprises: means for creating music pieces made up of a plurality of instrument/vocal parts; means for adding copyright information to each of the plurality of instrument/vocal parts; means for transferring, via a network, music pieces made up of the plurality of instrument/vocal parts to which the copyright information has been added; and means for registering the music pieces to a management center for management thereof so that other users can use the music pieces by individual instrument/vocal parts.

According to another aspect of the present invention, a music piece distributing system comprises: means for creating music pieces made up of a plurality of instrument/vocal parts; means for adding copyright information to each of the plurality of instrument/vocal parts; and means for registering to a community provided upon a network, the music pieces made up of the instrument/vocal parts with copyright information added to each of the instrument/vocal parts, so that other users can use the music pieces by each of the plurality of instrument/vocal parts.

Thus, music pieces made up of multiple instrument/vocal parts are created, copyright information is added to each of the multiple instrument/vocal parts, and the music pieces made up of the instrument/vocal parts with copyright information added to each of the instrument/vocal parts are registered to a management center or a community so that other users can use the music pieces.

According to another aspect of the present invention, a contents distributing system comprises: means for receiving contents created by a user and copyright information relating to the contents, via a network; means for encoding the contents following the copyright information; means for storing the encoded contents in a server for distributing the contents; and means for settling copyright usage fees relating to the contents, based on the copyright information.

Thus, contents created by a user and copyright information relating to the contents are received via a network, the contents are encoded following the copyright information, the encoded contents are stored in a server for distribution, and copyright usage fees relating to the contents are set, based on the copyright information.

According to another aspect of the present invention, a contents distributing system comprises: means for receiving contents created by a user and copyright information set to the contents, via a network; means for storing the contents in a distributing server connected to the network; and means for setting billing fees in the case of others using the -contents, based on the copyright information.

Thus, billing fees are settled in the case of others using the contents, based on the copyright information.

According to another aspect of the present invention, a music piece distributing system comprises: means for receiving, via a network, music pieces created by a user, and a plurality of sets of copyright information set to each of a plurality of instrument/vocal parts making up the music piece; means for encoding audio signals corresponding to the a plurality of instrument/vocal parts, according to the plurality of sets of copyright information; means for storing the encoded audio signals to a distributing server for each of the plurality of instrument/vocal parts; and means for settling copyright usage fees relating to the music piece, based on the plurality of sets of copyright information.

Thus, music pieces created by a user and multiple sets of copyright information set to each of the instrument/vocal parts making up the music piece are received via a network, audio signals corresponding to the multiple instrument/vocal parts are encoded according to the multiple sets of copyright information, the encoded audio signals are stored in a distributing server for each of the multiple instrument/vocal parts, and copyright usage fees relating to the music piece are settled, based on the multiple sets of copyright information.

According to another aspect of the present invention, a music piece distributing system comprises: means for receiving music pieces created by a user, and a plurality of sets of copyright information set to a plurality of instrument/vocal parts making up the music piece; means for storing the music piece in a distributing server connected to the network, by each instrument/vocal part; and means for setting billing fees in the case of others using the music piece, based on the plurality of sets of copyright information.

Thus, billing fees are settled in the case of others using the contents, based on the copyright information.

According to another aspect of the present invention, a service providing method comprises: a step for a plurality of members, belonging to a group made up of members having mutual relationships, to provide a virtual community for performing activities of cooperatively creating contents upon a network; a step for performing verification processing of access rights to the community in the event that there has been an access request via the network; and a step for providing services relating to activities of creating the contents to the verified members via the network.

According to another aspect of the present invention, a service providing method comprises: a step for providing upon a network a virtual community for performing creating activities of cooperatively creating new contents using contents provided from a plurality of members belonging to a group made up of members having mutual relationships; a step for verifying, in the event that there has been an access request from a user via the network, whether or not the user is a member having access rights to the community; and a step for providing services relating to activities of creating the contents to the verified member via the network.

According to another aspect of the present invention, a service providing method comprises: a step for a plurality of members, belonging to a group made up of predetermined members, to provide a virtual community for performing creating activities of cooperatively creating contents upon a network; a step for performing verification processing of access rights to the community in the event that there has been an access request via the network; and a step for providing services relating to activities of creating the contents to the verified members via the network.

According to another aspect of the present invention, a service providing method comprises: a step for providing upon a network a virtual community for a plurality of members belonging to a group made up of predetermined members to participate in creating activities of cooperatively creating new contents using contents provided from the plurality of members; a step for verifying, in the event that there has been an access request from a user via the network, whether or not the user is a member having access rights to the community; and a step for providing services relating to activities of creating the contents to the verified member via the network.

Thus, a virtual community is provided upon a network for multiple members belonging to a group to participate in cooperatively creating contents or creating new contents using contents provided from the multiple members, accesses to the community via the network are verified, and services relating to activities of creating the contents are provided to verified members via the network.

According to another aspect of the present invention, a service providing method comprises: a step for providing a virtual community on a network; a step for registering original contents to the community; a step for verifying, in the event that there has been an access request from a user via the network, whether or not the user is a member having access rights to the community; and a step for providing to the verified user, services for creating new contents by modifying or arranging original contents provided to the community, via the network.

According to another aspect of the present invention, a service providing method comprises: a step for registering original contents to a virtual community provided on a network; a step for performing verification processing regarding access rights to the community, for users making access requests via the network; a step for providing to the verified users, services for modifying or arranging original contents provided to the community and creating new contents, via the network; and a step for distributing the contents to the verified users via the network.

According to another aspect of the present invention, a service providing method comprises: a step for performing verification processing regarding access rights to a virtual community provided on a network, for users making access requests via the network; and a step for providing to the verified users, contents registered in the community, and services for arranging or modifying the contents, via the network.

Thus, a virtual community is provided upon a network, original contents are registered thereto, access rights are verified for users making access requests via the network, verified users are provided with contents registered in the community and services for arranging or modifying the contents to create new contents, and the contents are provided to verified users via the network.

### BRIEF DESCRIPTION OF THE DRAWINGS

FIG. 1 is a diagram describing a music data distribution system;

FIG. 2 is a block diagram illustrating the configuration of the management center shown in FIG. 1;

FIG. 3 is a block diagram illustrating the configuration of the terminal device shown in FIG. 1;

FIG. 4 is a diagram describing track distribution project data;

FIG. 5 is a diagram describing stereo distribution project data;

FIG. 6 is a diagram describing contract formats;

FIG. 7 is a flowchart describing contract formats;

FIG. 8 is a flowchart describing project data registration processing in a terminal device of a user;

FIG. 9 is a diagram describing a setting screen at the time of activating an interface tool;

FIG. 10 is a flowchart describing project data registration processing at a management center;

FIG. 11 is also a flowchart describing project data registration processing at the management center;

FIG. 12 is a flowchart describing billing calculation processing.

FIG. 13 is a flowchart describing music piece data purchasing;

FIG. 14 is a diagram describing a community; and

FIG. 15 is a flowchart describing processing in the community.

### DESCRIPTION OF THE PREFERRED EMBODIMENTS

The following is a description of an embodiment according to the present invention, with reference to the drawings.

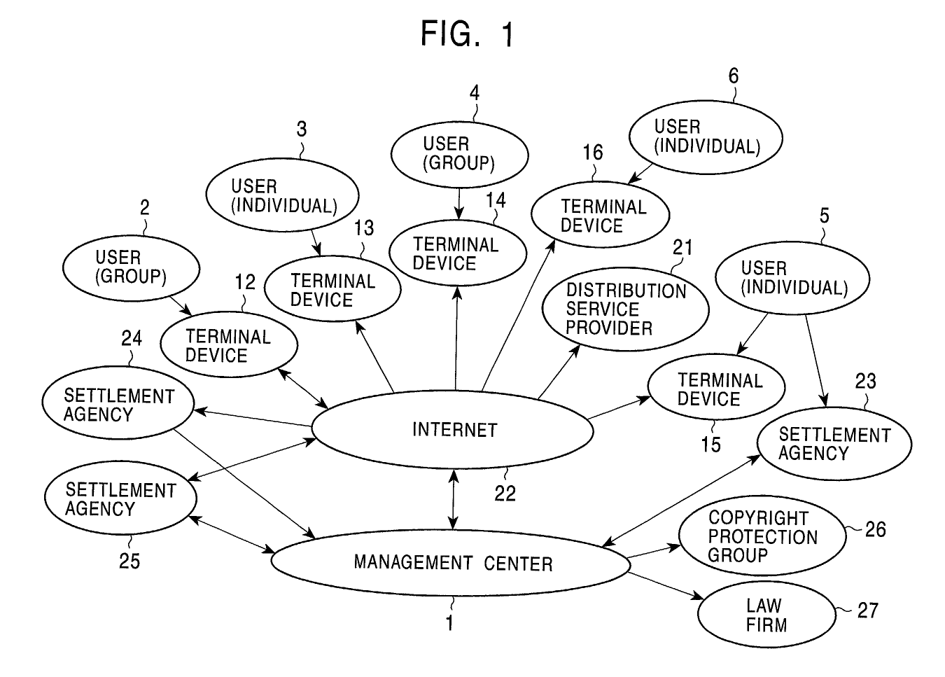

FIG. 1 illustrates the configuration of a music distribution system to which the present invention has been applied.

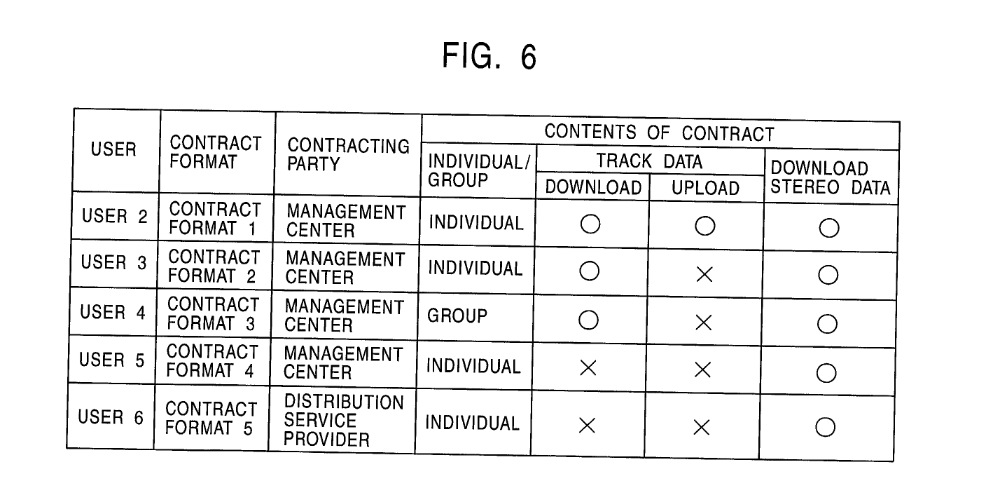

A management center 1, terminal devices 12 through 16, a distribution service provider 21, and settlement agencies 24 and 25 are mutually connected via the Internet 22. Users 2 through 6 who use the terminal devices 12 through 16 differ in the services which each can receive, depending on the contracts thereof with the management center 1 or the distribution service provider 21, and in this example, the contract format of the user 2 which uses the terminal device 12 will be referred to as contract format 1, the contract format of the user 3 which uses the terminal device 13 as contract format 2, the contract format of the user 4 which uses the terminal device 14 as contract format 3, the contract format of the user 5 which uses the terminal device 15 as contract format 4, and the contract format of the user 6 which uses the terminal device 16 as contract format 5. Now, let us say that the users 2 through 5 have entered into contract with the management center 1, and the user 6 has entered into contract with the distribution service provider 21. The contract formats 1 through 5 will be described later with reference to FIG. 6.

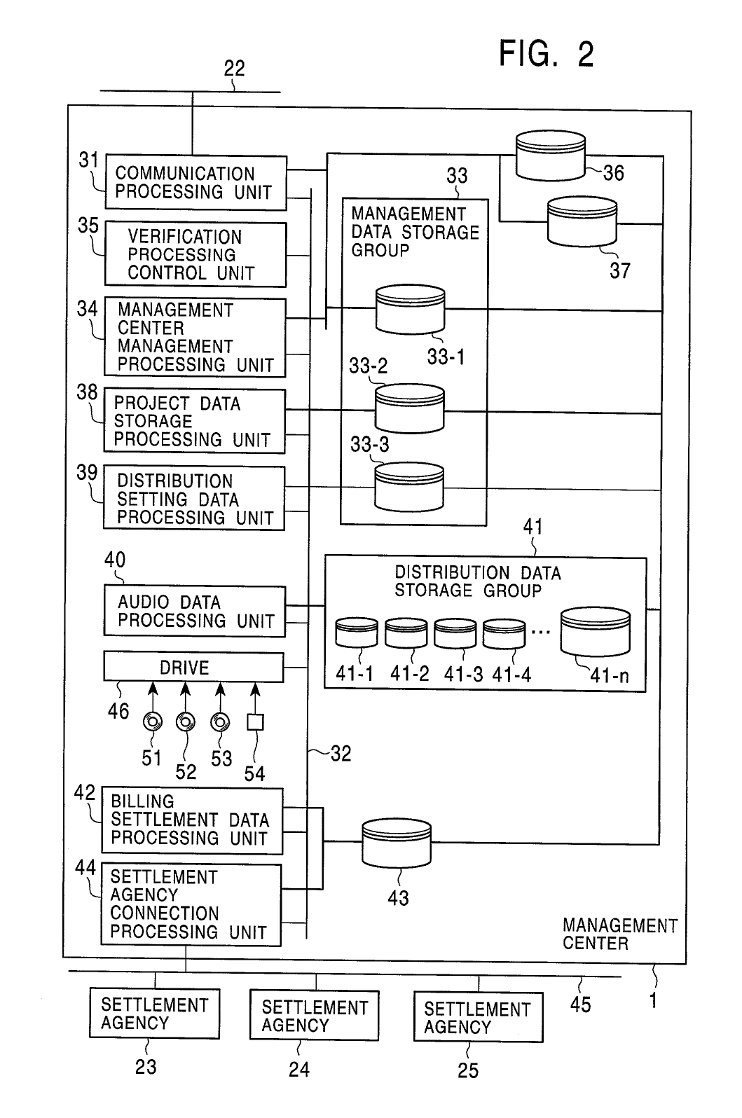

The management center 1 receives the charges for the services supplied to the users 2 through 5, through the intermediation of the settlement agencies 23 through 25. In FIG. 1 shows the management center 1 and the settlement agencies 23 through 25 being connected by individually independent networks, but the management center 1 and the settlement agencies 23 through 25 may be connected by, for example, a financial agency network 45 (FIG. 2) other than the Internet 22, or may be connected one to another via the Internet 22.

Also, the management center 1 performs later-described services such as paying a batch sum for copyright managing fees copyright managing fees to a copyright protection group 26 for example, for the music data handled by the management center 1 which is the object of copyright protection, introducing an agency such as a law firm 27 which performs services relating to copyrights to the users 2 through 5 as necessary, in the event that the users 2 through 5 who have entered into contract with the management center 1 desire intermediation of a third party in contracts regarding to copyrights an otherwise, and so forth.

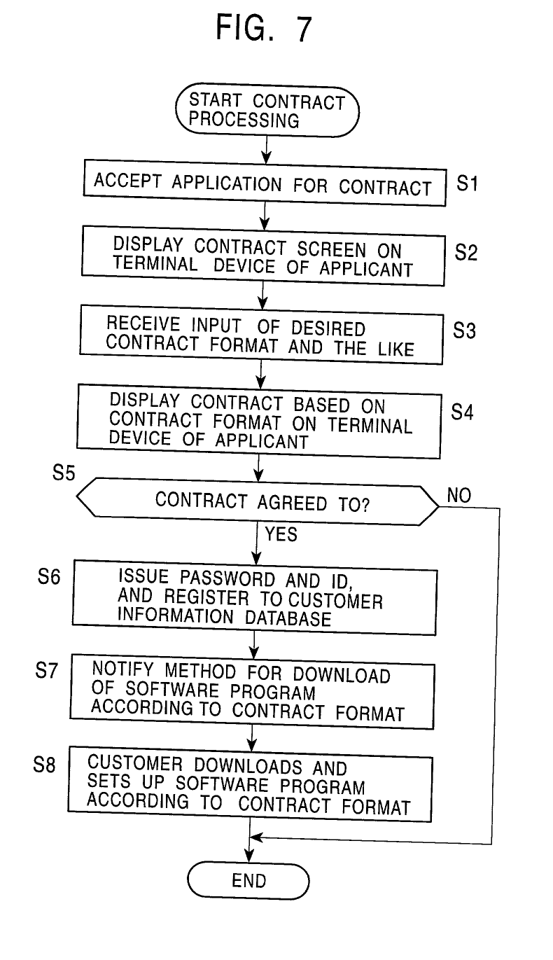

The users 2 through 5 use the terminal devices 12 through 15 to make user registration at the management center 1 by processing described later with reference to FIG. 7, receive services based on the contents of the contracts, and pay charges for the services received via the settlement agencies 23 through 25. Also, depending on the contract with the management center 1, the users 2 through 5 can create pay music data, and allow a third party registered with the management center 1 to use this data, via the management center 1.

The settlement agencies 23 through 25 perform intermediation of payment of charges for services which the management center 1 has supplied to the users 2 through 5 and music data which the users have downloaded from the management center 1. Details of payment methods for the charges will be described later.

The distribution service provider 21 has entered into contract with the management center 1 so as to receive supply of music data from the management center 1 via the Internet 22. The distribution service provider 21 supplies music data to the user 6 according to an independent contract format which is different to that of the management center 1.

The copyright protection group 26 receives stipulated copyright management fees from the management center 1, and manages copyrights of the registered music price data. The law firm 27 performs legal intermediation of contracts between corresponding users and the management center 1 upon introduction or commission from the management center 1.

FIG. 2 is a block diagram illustrating the configuration of the management center 1.

A communication processing unit 31 supplies user IDs and passwords input via the Internet 22 to a verification processing control unit 35 via an internal bus 32, and in the event that confirmation has been made that the user ID and password are correct, by the processing of the verification processing control unit 35, subsequently input various types of signals are supplied to a management center management processing unit 34 via the internal bus 32. Also, in the event of receiving a request for a new contract, a communication processing unit 31 receives data transmitted from the user who desires the new contract via the Internet 22, and outputs this to the verification processing control unit 35 via the internal bus 32. Further, the communication processing unit 31 also, discloses predetermined Web pages (home pages) from as Web page storage database 36 on the Internet 22, downloads software saved in a software storage database 37 to a predetermined terminal device via the Internet 22 according to control of the management center management processing unit 34, and so forth.

The verification processing control unit 35 executes verification processing for a contract with a new user, based on data corresponding to the user desiring new registration, input from the communication processing unit 31 via the internal bus 32. Also, the verification processing control unit 35 makes query if the user ID and password input from the communication processing unit 31 with the customer information database 33-1 in the management data storage group 33 via the internal bus 32, to verify that the user is a registered user. Further, processing relating to verification of the later-described community is also executed by the verification processing control unit 35. Contract processing will be described later with reference to FIG. 7.

The management center management processing unit 34 inputs via the internal bus 32 control signals generated by the communication processing unit 31 based on data input from the users 2 through 5 via the Internet 22, generates control signals for causing one of the project data storage processing unit 38 through settlement agency connection processing unit 44 to execute predetermined processing, and outputs the generated control signals to one of the project data storage processing unit 38 through settlement agency connection processing unit 44 via the internal bus 32. For example, in the event that data input from the communication processing unit 31 is signals transmitted from the terminal device 12 indicating an upload request of project data which will be described later, the control signals commanding storing of the corresponding project data are output to the project data storage processing unit 38 via the internal bus 32, and the input project data is stored in the project data database 33-2.

The project data storage processing unit 38 stores new project data input via the internal bus 32 to the project data database 33-2 according to control signals input from the management center management processing unit 34, reads out corresponding project data from the project data database 33-2 in the event of receiving a download request for project data and outputs the data to the communication processing unit 31 via the internal bus 32, and so forth.

A distribution setting data processing unit 39 registers in the distribution settings database 33-3 copyright data and the like necessary for distribution of each piece of music piece data according to control signals input from the management center management processing unit 34 via the internal bus 32, reads out corresponding copyright information from the distribution settings database 33-3 at the time of distributing the music piece data and outputs this information to a billing settlement data processing unit 42 via the internal bus 32, and so forth.

An audio data processing unit 40 converts input music data into a predetermined format following control signals input from the management center management processing unit 34 via the internal bus 32 and registers the converted data into a corresponding database in the distribution data storage group 41, reads in music data from which there has been a request from the database in the distribution data storage group 41 wherein the data of the corresponding format is stored and outputs the data to the communication processing unit 31 via the internal bus 32, and so forth. The distribution data storage group 41 is made up of, for example, an MP3 storage database 41-1, an ATRAC storage database 41-2, an AAC storage database 41-3, a stereo data storage database 41-4, a non-compressed project storage database 41-n, and so forth, according to data format.

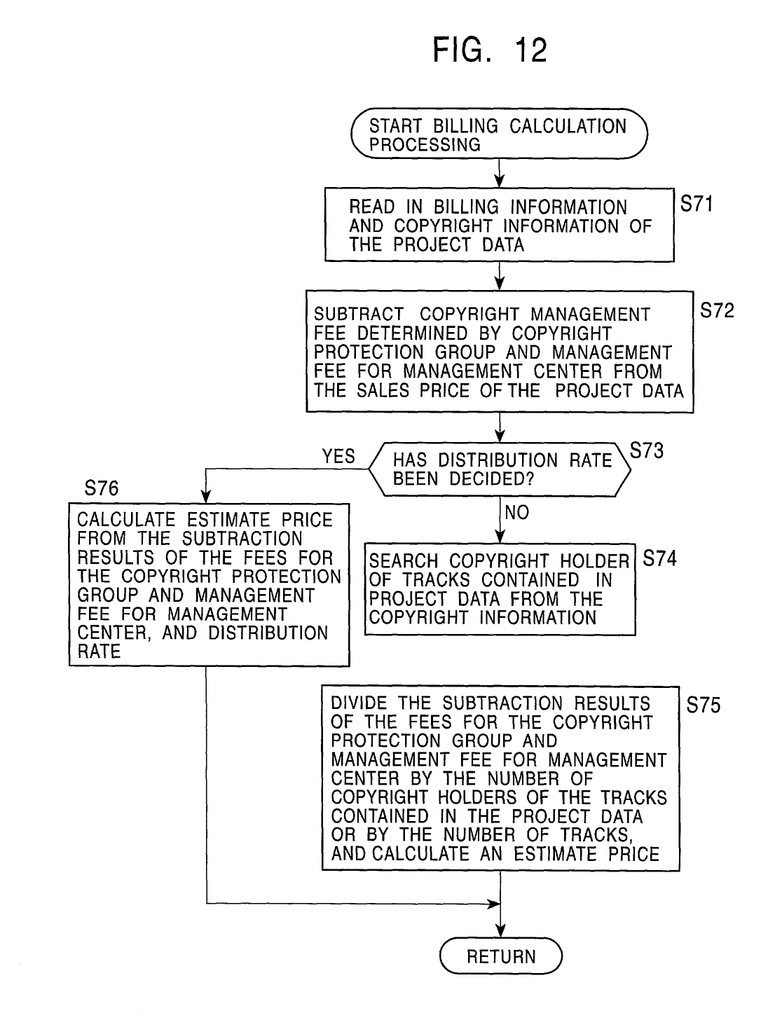

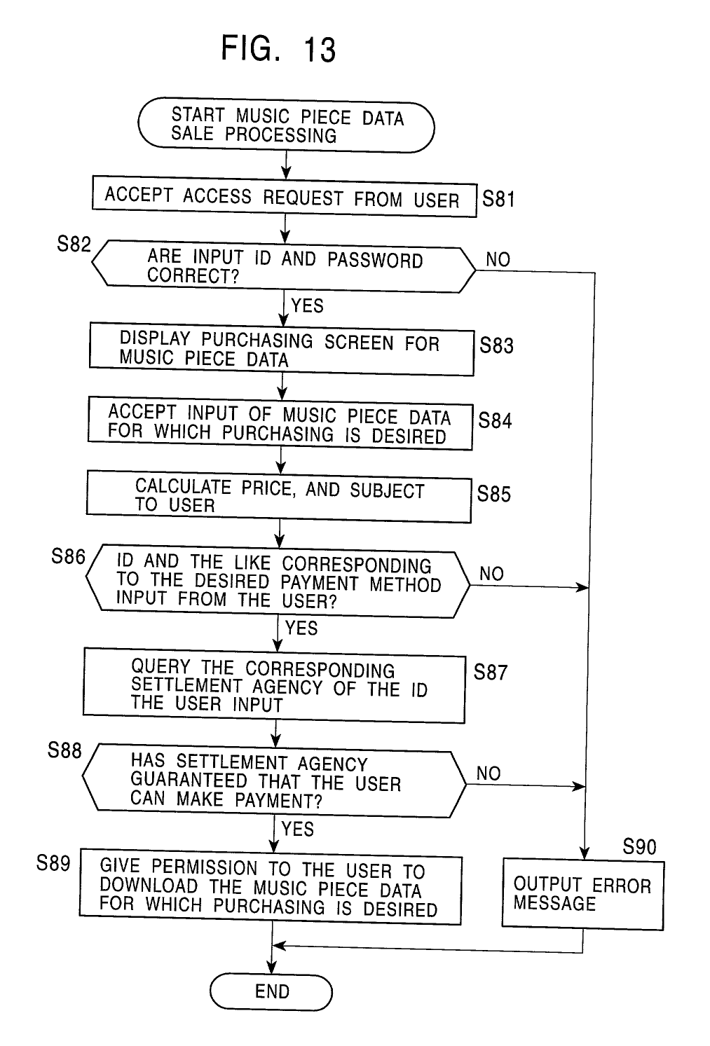

The billing settlement data processing unit 42 calculates the billing amount per person in the event that, for example, multiple copyright holders have created on set of project data (details described later with reference to FIG. 12) in accordance with control signals input from the management center management processing unit 34 via the internal bus 32 and registers this billing amount to the billing settlement database 43, calculates the charges for the services the users 2 through 5 receive from the management center 1 such as downloading music data (details described later with reference to FIG. 13) and outputs these charges to the communication processing unit 31 via the internal bus 32, and so forth. The communication processing unit 31 searches and reads out corresponding Web pages from the Web page storage database 36, and transmits the calculation results to a predetermined terminal device via the Internet 22 in order to display on the monitor or the like of the terminal device used by the user. Also, the billing settlement data processing unit 42 generates signals for invoicing charges for service supplied to the users 2 through 5, and transmits these to one of the settlement agencies 23 through 25 via the settlement agency connection processing unit 44 and financial agency network 45.

The settlement agency connection processing unit 44 generates signals for inquiring one of the corresponding settlement agencies 23 through 25 whether or not the payment method which the user has specified is valid, and outputs the signals via the Internet 22 to one of the settlement agencies 23 through 25. Then, the settlement agency connection processing unit 44 outputs the reply returned from one of the settlement agencies 23 through 25 in response to the inquiry to the management center management processing unit 34 and billing settlement data processing unit 42, via the internal bus 32. Also, the settlement agency connection processing unit 44 receives input of signals for invoicing the users 2 through 5 of the charges for the services provided thereto which have been calculated by the billing settlement data processing unit 42, and transmits the signals to one of the settlement agencies 23 through 25 via the financial agency network 45.

Also, a drive 46 is also connected to the internal bus 32, and exchanges data with an electromagnetic disk 51, optical disk 52, magneto-optical disk 53, semiconductor memory 54, and so forth, which are mounted as necessary.

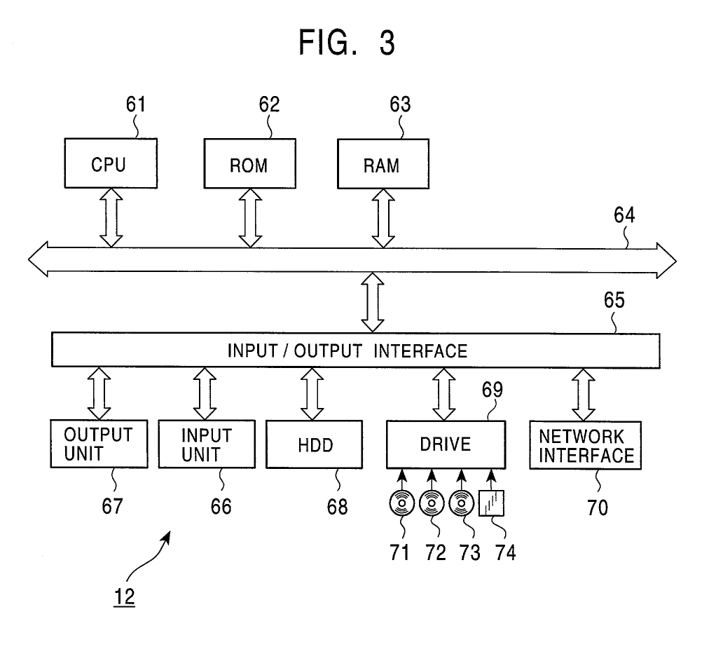

FIG. 3 is a block diagram illustrating the configuration of the terminal device 12 used by the user 2. Note that the configuration of the terminal devices 13 through 16 is the same as that of the terminal device 12, and accordingly description thereof will be omitted.

The CPU (Central Processing Unit) 61 actually executes various application programs and the basic operating system. ROM (Read-Only Memory) 62 generally stores basically fixed data of programs used by the CPU 61 and parameters for computation. RAM (Random-Access Memory) 63 stores programs used in the execution of the CPU 61 and parameters which change as necessary according to the execution thereof. The CPU 61, ROM 62, and RAM 63 are mutually connected by an internal bus 64.

The internal bus 64 is also connected to an input/output interface. The input unit 66 is made up of, for example, a keyboard and mouse, and is operated by the user at the time of inputting various commands to the CPU 61. The output unit 67 is made up of, for example, a CRT and speaker and the like, for displaying various types of information by text, images, or audio. A hard disk drive 68 drives a hard disk, thereby recording and playing programs and information to be executed by the CPU 61. An electromagnetic disk 71, optical disk 72, magneto-optical disk 73, and semiconductor memory 74 are mounted to a drive 69 as necessary, for exchanging data. A network interface 70 is connected, for example, to the Internet 22 via a telephone line, connected to other terminal devices such as a digital audio recorder not shown in the drawings, and so forth.

The input unit 66 through the network interface 70 are connected to the CPU 61 via the input/output interface 65 and the internal bus 64.

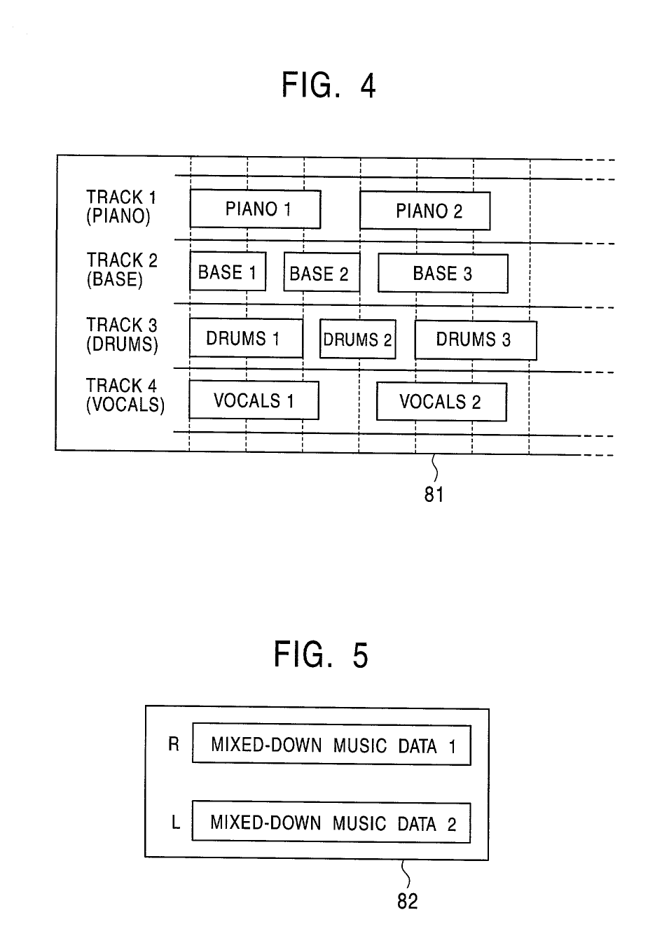

FIG. 4 shows a configuration example of music data handled by the management center 1, which is exchanged with the terminal devices 12 through 16 via the Internet 22. Here, the music data of each part, such as the drums, base, piano, etc., making up a music piece, is referred to as a track, and music data made up of one or multiple tracks is referred to as project data.

Let us consider music data made up of four parts; a piano, a base, drums, and a vocal. The project data 81 which the management center 1 uses is made up of four tracks with each part independently existing on one of these, as shown in FIG. 4. Also, independent copyright information is correlated to the tracks 1 through 4. That is to say, even in the event that the music data of the tracks 1 through 4 has been created by different creators, copyright information is recorded on each of the tracks 1 through 4. Even in a case wherein a new track for a new part is added to the project data 81 for example, thereby generating different project data, the copyright information on each track is not deleted.

Also, the management center 1 is capable of handling not only project data 81 made up of tracks with independent parts such as described with reference to FIG. 4, but also to conventional stereo data such as the project data 82 shown in FIG. 5, generated by mixing down multiple sets of music data. Further, an arrangement may be made wherein, instead of using the Internet 22, predetermined project data is recorded on a recording medium such as, for example, an electromagnetic disk 51, optical disk 52, magneto-optical disk 53, semiconductor memory 54, and so forth, such as shown in FIG. 2, and supplied to the users 2 through 5 by means such as postal delivery or the like, for example.

Next, the contract formats 1 through 5 between the management center 1 or the distribution service provider 21 and the users 2 through 6 will be described. FIG. 6 illustrates the contract formats which the users 2 through 6 have entered into in the present embodiment.

The user 2 has entered into contract with the management center 1 under the contract format 1. The contract format 1 is an individual contract, which allows downloading and uploading of track data described with reference to FIG. 4, and downloading and uploading of stereo data described with reference to FIG. 5, i.e., receiving all services.

The user 3 has entered into contract with the management center 1 under the contract format 2. The contract format 2 is an individual contract, which allows receiving of the services of downloading of track data described with reference to FIG. 4, and downloading of stereo data described with reference to FIG. 5.

The user 4 is a school or the like for example, which has entered into contract with the management center 1 under the contract format 3. The contract format 3 is a group contract, which allows downloading of track data described with reference to FIG. 4, and downloading of stereo data described with reference to FIG. 5. The difference between this contract format and the contract format 2 is whether the contracting party is an individual or an organization, and arrangements may be made wherein contract charges differ depending on the type of contract format here, for example, or wherein the number of times a piece of software downloaded at the time of contract processing described later with reference to FIG. 7 can be copied (i.e., the number of licenses) differs.

The user 5 has entered into contract with the management center 1 under the contract format 4. The contract format 4 is an individual contract, which allows downloading of stereo data described with reference to FIG. 5.

The contracts between the users 2 through 5 and the management center 1 may be arranged so as to be a fixed membership system wherein the users pay a fixed amount monthly for example, such that the management center 1 has stable income. The users 2 through 5 have entered into contract with the management center 1, and thus can receive the accessory services of introduction to the above-described law firm 27 and so forth. Also, in the event of the users 2 through 5 downloading software programs saved in the software storage database 37 of the management center 1 in the later-descried step S7 in FIG. 7, the software programs which can be downloaded differ according to the contract format.

The user 6 has entered into contract with the distribution service provider 21 under the contract format 6. The contract format 6 is an individual contract, which allows receiving of the services of downloading of stereo data described with reference to FIG. 5 from the distribution service provider 21, but the user 6 has not entered into contract with the management center 1. That is to say, the user 6 cannot download contents (music piece data) from the management center 1.

Next, description will be made regarding an example of a payment method whereby the users 2 through 5 which have entered into contract with the management center 1 make payment of charges to the management center 1, through the intermediation of the settlement agencies 23 through 25. As for the types of settlement, examples include settlement by credit card, settlement by pre-paid card, settlement by pre-registered ID, and so forth.

The settlement agency 23 shown in FIG. 1 is a credit card company. For example, in the event that the user 5 enters into contract with the management center 1 via the Internet 22, or purchases contents (music piece data) from the management center 1, and the user 5 selects payment by credit card, the user 5 inputs a credit card No. into the credit card No. input screen on a Web page which the management center 1 provides on the Internet, for example, thereby transmitting the credit card No. to the management center 1 via the Internet 22.

The management center 1 makes query of the transmitted credit card No. to the settlement agency 23, and following making confirmation that the user 5 is capable of making payment of the charges by that credit card, the management center 1 closes the contract or transmits the contents download method via the Internet 22. Then, the management center 1 invoices the settlement agency 23 for the usage charges of the user 5, and the settlement agency 23 invoices the user 5 for the same.

The settlement agency 24 is an agency which provides services of making payments for the user, by the pre-paid card method. The pre-paid card used here for payments on the Internet 22 is commonly marketed, and is arranged such that each card has a unique ID, which the purchaser thereof alone obtains by scratching off a scratch patch which initially hides the ID.

For example, in the event that the user 2 purchases a pre-paid card beforehand, and enters into contract with the management center 1 via the Internet 22, or purchases contents from the management center 1, and the user 2 selects payment by pre-paid card, the user 2 inputs the ID printed on the scratch portion of the pre-paid card into the ID input screen on a Web page which the management center 1 provides, for example, thereby transmitting the credit card No. to the management center 1 via the Internet 22.

The management center 1 makes query of the transmitted ID to the settlement agency 24, and following making confirmation that the remaining funds of the pre-paid card of the input ID are sufficient to cover the usage charges, the management center 1 closes the contract or transmits the contents download method via the Internet 22. Then, the management center 1 invoices the settlement agency 24 for the usage charges of the user 2. Also, the settlement agency 24 can also provide the user 2 with various services (e.g., queries for the remaining funds for each ID No., integrating multiple pre-paid cards with few remaining funds into one pre-paid card, and so forth) via the Internet 22.

The settlement agency 25 shown in FIG. 1 is a company which provides services of making payments for of the user, by the pre-registration ID settlement method. Users who want to pay charges using the pre-registration ID settlement method enter into contract with the settlement agency 25 beforehand, contact the settlement agency 25 by, for example, mailing a credit card No. or some other like means, thus registering with the settlement agency 25 and obtaining an ID beforehand.

For example, in the event that the user 3 enters into contract with the management center 1 via the Internet 22, or purchases contents from the management center 1, and the user 3 selects payment by the pre-registration ID settlement method, the user 3 inputs the pre-registered ID into the ID input screen on a Web page which the management center 1 provides on the Internet, for example, thereby transmitting the ID to the management center 1 via the Internet.

The management center 1 makes query of the transmitted ID to the settlement agency 25, and following making confirmation that the user 3 is capable of making payment of the charges by the credit card or the like registered by the user 3 for this ID, the management center 1 closes the contract or transmits the contents download method via the Internet 22. Then, the management center 1 invoices the settlement agency 25 for the usage charges of the user 3, and the settlement agency 23 invoices the credit card company for the same.

The users 2 through 5 can select any one of the settlement agencies 23 through 24 as payment methods for fees or charges at the time of entering into contract or purchasing contents. However, the payment method of the user 6 is carried out based on the contract with the distribution service provider 21, and thus the user 6 does not have this freedom of selection.

Now, in the event that music data created by the user 2 which has entered into contract under the contract format 1 has been used (purchased) by other users of the distribution service provider 21 via the management center 1, charges corresponding to the music data calculated by the later-described method with reference to FIG. 12 are paid to the user 2 from the management center 1. In this case, a method is used such as a monetary amount for the music data being transferred into an account of the user 2 in a financial firm such as a bank or the like from the management center, or so forth.

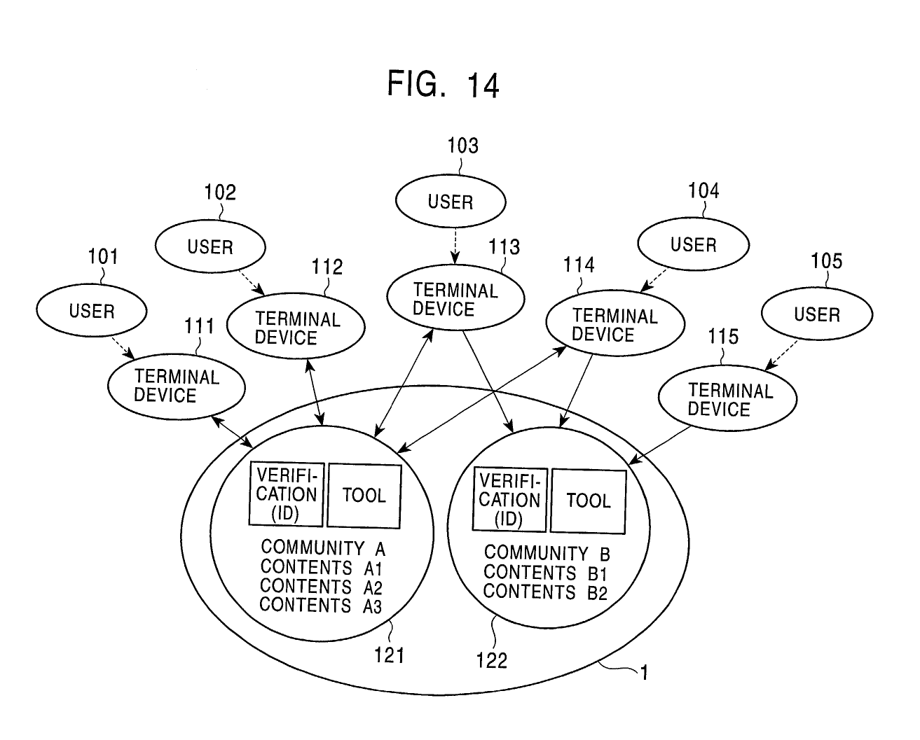

Also, participants in the community described later with reference to FIG. 14 are also billed. For example, a method may be used wherein billing occurs at the point of registering with the community. The billing method may either involve billing each community a predetermined amount, or setting different charges for each community.

Now, the contract processing in the event that a new user has applied for a contract to the management center 1 will be described with reference to the flowchart shown in FIG. 7.

A Web page enabling application for a contract with a description of the overview of the management center 1 is saved in the Web page storage database 36, and is disclosed on the Internet 22 via the communication processing unit 31. In step S1, the communication processing unit 31 of the management center 1 receives signals indicating application for contract from a terminal device (not shown) of an applicant desiring a new contract, via the Internet 22.

In step S2, the communication processing unit 31 selects from the Web page storage database 36 a desired contract format wherein the contract contents between the management center 1 and the user are described (e.g., one of the contract formats 1 through 4 described with reference to FIG. 6), reads out a Web page containing an input form whereby the applicant can input personal information, and transmits this to the terminal device of the applicant via the Internet 22.

In step S3, the communication processing unit 31 receives input of the desired contract format and the personal information and the like of the applicant, from the terminal device of the applicant via the Internet 22, and outputs this to the verification processing control unit 35 via the internal bus 32.

In step S4, the verification processing control unit 35 transmits the information corresponding to the predetermined contract to the terminal device of the applicant via the Internet 22, according to the contact format which the applicant desires and which has been input in step S3, and the information is displayed on a monitor or the like not shown in the drawings.

In step S5, the communication processing unit 31 judges whether or not signals indicating agreement to the contract have been input from the terminal device of the applicant via the Internet 22. In the event that judgment is made that signals indicating agreement to the contract have not been input, the processing ends.

In step S5, in the event that judgment is made that signals indicating agreement to the contract have been input, in step S6 the communication processing unit 31 outputs signals indicating that signals indicating agreement to the contract have been input to the verification processing control unit 35 via the internal bus 32. The verification processing control unit 35 issues a new password and ID for the applicant, which are transmitted to the terminal device of the applicant via the communication processing unit 31 and the Internet 22, and also generates control signals for registering the individual information of the applicant, and the new password and ID, to the customer information database 33-1, and outputs this to the management center management processing unit 34 via the internal bus 32. The management center management processing unit 34 registers the individual information of the applicant, and the new password and ID thereof, to the customer information database 33-1, according to the input control signals.

In step S7, the management center management processing unit 34 transmits to the terminal device of the applicant a method for downloading a software program according to the contract format of the applicant, out of software programs registered in the software storage database 37, such as a software program for generating project data, an interface tool activating program, a software program for decoding downloaded data, and so forth, via the communication processing unit 31 and the Internet 22.

In step S8, a predetermined software program is downloaded by the terminal device of the applicant via the Internet 22 according to the downloading method transmitted in step S7, and the applicant sets up the software on the terminal device of the applicant, thereby ending this processing.

Also, an arrangement may be made wherein the user can execute encoding processing which the management center 1 is executing, by providing the encoder or compressing software used for the encoding processing executed by the management center 1. This enables compressing of the music data at the time of uploading the music data to the management center 1, thereby reducing the data transfer amount and relieving the cost of data transfer.

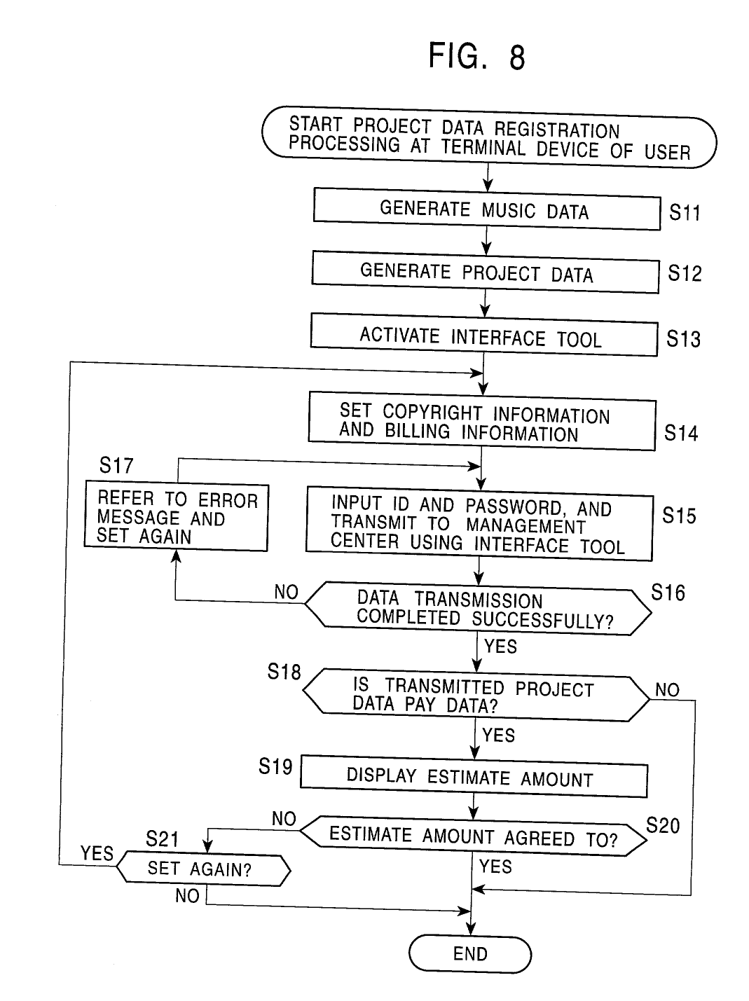

Next, the registration processing of the project data which the terminal device 12 of the user 2, which has entered into contract under the contract format 1 described with reference to FIG. 6 in the contract processing described with reference to FIG. 7 executes, will be described with reference to FIG. 8.

In step S11, the user 2 generates music data, and records this on the hard disk drive 68. This music data may be recorded by, for example, a digital audio recorder not shown in the drawings, taken in via a network interface, and recorded on the hard disk drive 68, or, may be generated by the processing of generally used music data generating software or music data generating software downloaded from the management center 1 which is read into the RAM 63 and activated, whereby the music data is recorded on the hard disk drive 68.

In step S12, the CPU 61 causes the project data generating software downloaded from the management center 1 in step S7 of FIG. 7 and set up in step S8 to be read into the RAM 63 and activated, whereby project data is generated from the music data recorded on the hard disk drive 68 in step S11. This project data contains at least one track or stereo data, with each track having independently-existing copyright information, as described with reference to FIG. 4. For example, in the event that new project data is generated using a track with copyright information already recorded thereto, the copyright information of the user 2 which has created the newly-generated track is recorded to this newly-generated track alone.

In step S13, the CPU 61 causes the interface tool downloaded from the management center 1 in step S7 of FIG. 7 and set up in step S8 to be read into the RAM 63 and activated.

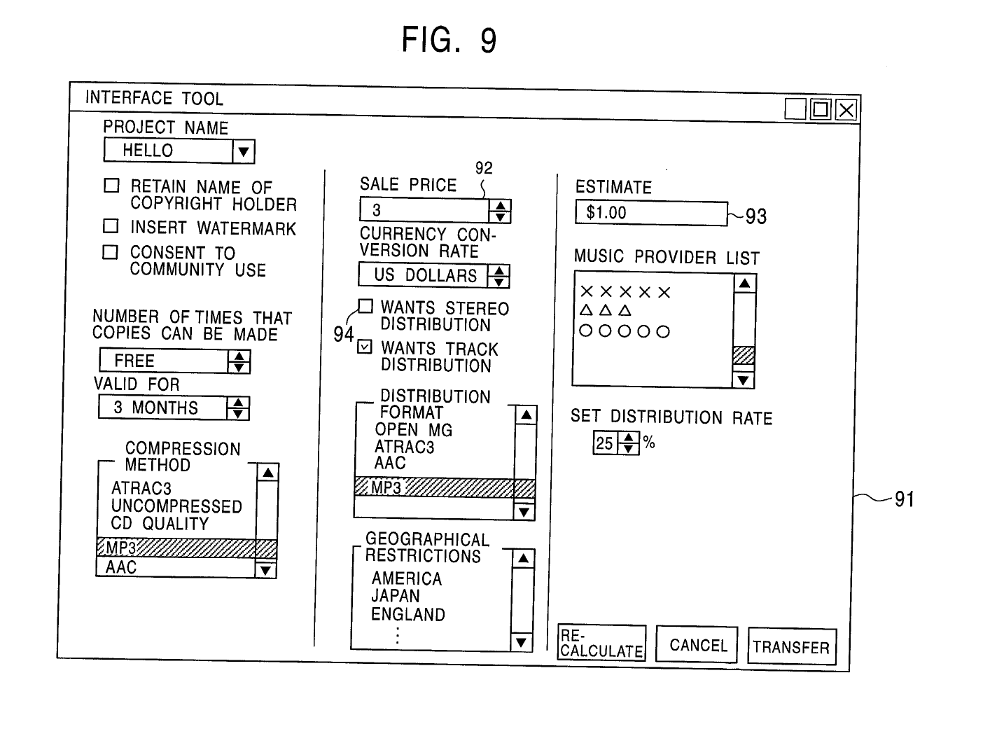

In step S14, the user 2 sets copyright information and billing information and the like, while making reference to a setting screen 91 such as shown in FIG. 9 for example, displayed on the output unit 67 in the event that the interface tool has been activated. The setting screen 91 has, in addition to the sale price setting text box 92 and the estimate results display box 93 which displays the results of an estimate of fees paid to the user (calculation of the estimate will be described later), various types of settings text boxes and list boxes and the like, such as a check box 94 for selecting whether or not stereo distribution is desired, for example. The CPU 61 receives input of various settings input by the user using the input unit 66, via the input/output interface 65 and internal bus 64.

In step S15, the CPU 61 transmits the contents set in step S14, along with the ID and password input by the user 2 in an ID and password input screen not shown in the drawings, via the internal bus 64, input/output interface 65, network interface 70, and Internet 22. The management center 1 confirms the transmitted ID and password by later-described processing, and in the event that judgment is made that the ID and password are correct, the management center 1 transmits a signal notifying reception of the data to the terminal device 12 via the Internet 22, but the event that judgment is made that either one or both of the ID and password are not correct, the management center 1 transmits an error message thereto.

In step S16, the CPU 61 judges whether or not transmission of data has been successfully completed, based on signals transmitted from the management center 1 via the Internet 22, and input via the network interface 70, input/output interface 65, and the internal bus 64.

In the event that judgment is made in step S16 that transmission of data has not been successfully completed (i.e., an error message has been received), in step S17 the user 2 makes reference to the error message and performs settings again, the cPu 61 is input with signals indicating the contents of setting again which the user 2 has input using the input unit 66, via the input/output interface 65 and the internal bus 64, the processing returns to step S15, and subsequent processing is repeated.

In step S16, in the event that judgment is made that transmission of data has been successfully completed, in step S128 the CPU 61 judges whether or not the project data transmitted in step S15 is pay data, from the billing information set in step S14. In the event that judgment is made in step S18 that the transmitted project data is not pay data, the processing ends.

In the event that judgment is made in step S18 that the transmitted project data is pay data, the management center 1 transmits an estimated amount of the fees paid to the user 2 in the event that the project data is purchased by another user, which is displayed in the estimate results display box 93 of the setting screen 91 displayed on the output unit 67, so in step S19 the user 2 confirms the estimated amount displayed in the estimate results display box 93.

In step S 20, the CPU 61 judges whether or not the user 2 has agreed to the estimated amount, based on the signals indicating the operation of the user 2 input from the input unit 66 via the input/output interface 65 and the internal bus 64 (e.g., based on whether or not the transfer button has been selected on the setting screen 91). In the event that judgment is made in step S20 that the estimated amount has been agreed to, the processing ends.

In the event that judgment is made in step S20 that the estimated amount has not been agreed to, in step S21 the CPU 61 judges whether or not the user 2 has set the billing information again, based on the signals indicating the operation of the user 2 input from the input unit 66 via the input/output interface 65 and the internal bus 64 (e.g., based on whether or not the re-calculate button has been selected on the setting screen 91).

In the event that judgment is made in step S21 that settings have been made again, the flow returns to step S14, and the subsequent processing is repeated. In the event that judgment is made in step S21 that settings have not been made again, the flow ends.

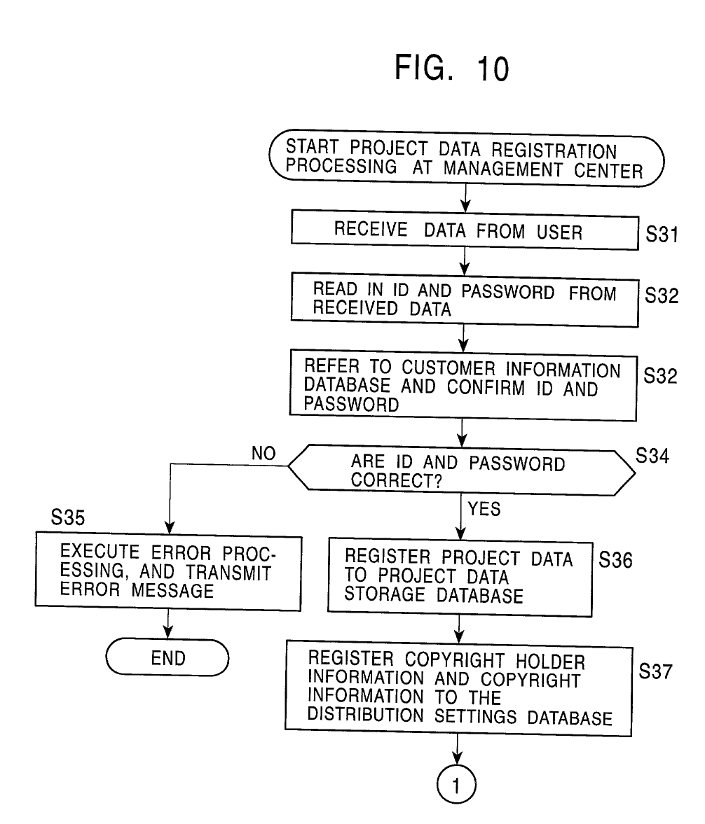

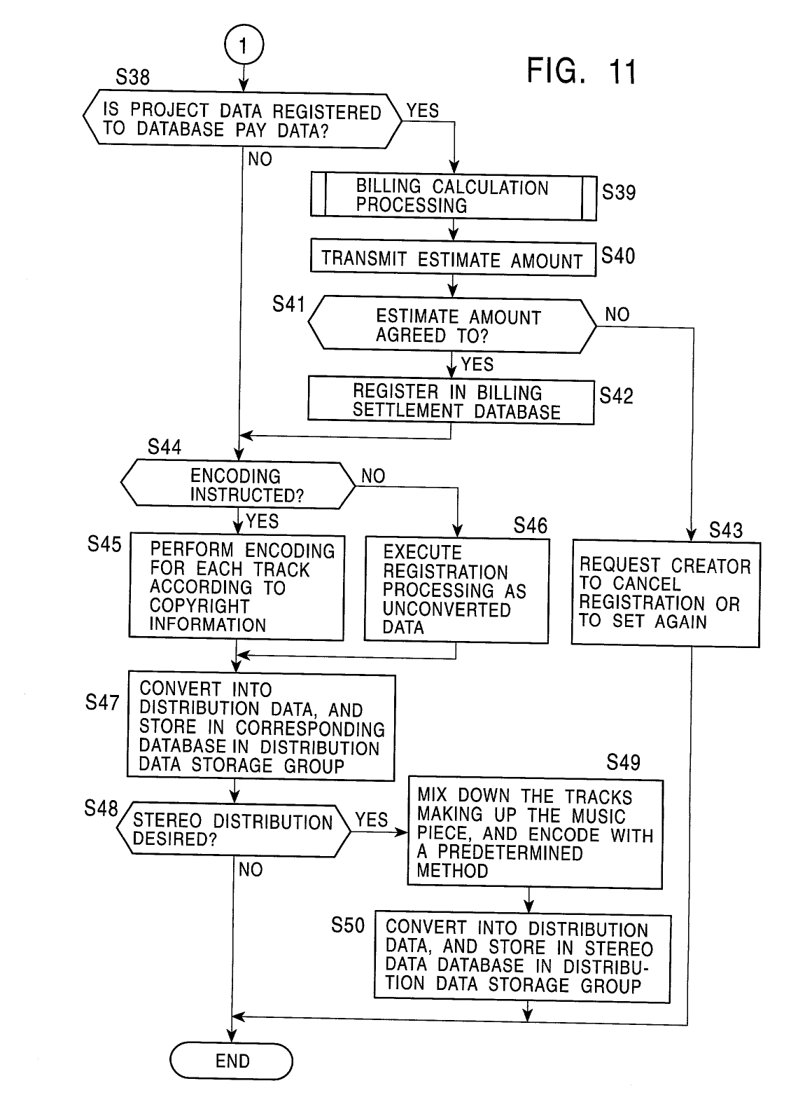

Next, description will be made regarding the project data registration processing at the management center 1, with reference to the flowcharts in FIGS. 10 and 11.

In step S31, the communication processing unit 31 of the management center 1 receives the project data, ID, and password transmitted form the terminal device 12 of the user 2 in step S15 shown in FIG. 8, and outputs the ID and password to the verification processing control unit 35 via the internal bus 32.

In step S32, the verification processing control unit 35 reads in the ID and password output from the communication processing unit 31 in step S31, makes reference to the customer information database 33-1 in step S33, confirms the ID and password, and in step S34 judges whether or not the ID and password are correct.

In the event that judgment is made in step S34 that either one or both of the ID and password are not correct, in step S35 the verification processing control unit 35 executes error processing, transmits an error message to the terminal device 12 of the user via the communication processing unit 31 and the Internet 22, and the processing ends.

In the event that judgment is made in step S34 that the ID and password are correct, in step S36 the verification processing control unit 35 outputs a signal indicating that the user 2 has been registered to the communication processing unit 31 via the internal bus 32. The communication processing unit 31 supplies the data received in step S31 to the management center management processing unit 34 via the internal bus 32. The management center management processing unit 34 outputs the project data contained in the data supplied to the project data storage processing unit 38 via the internal bus 32. The project data storage processing unit 38 registers the project data in the project data storage database 33-2, and also outputs the project data to the audio data processing unit 40.

Now, in order to correlate the project data and data relating thereto, an arrangement may be made wherein the management center management processing unit 34 issues a project data ID unique to the project data, for example, such that the project data ID is attached and stored at the time of storing the project data and the other data.

In step S37, the management center management processing unit 34 reads out the information of the copyright holder (i.e., the user 2) from the customer information database 33-1 based on the ID contained in the data supplied in step s34, and outputs this information to the distribution settings data processing unit 39 along with the copyright information contained in the project data. The distribution settings data processing unit 39 registers the copyright hold information and the copyright information in the distribution settings database 33-3.

In step S38, the management center management processing unit 34 judges whether or not the project data registered in the project data storage database 33-2 in step S36 is to be paid for at the time of distribution (i.e., whether or not the user 2 has set the sale price to a value other than zero using the sale price setting text box 92 of the setting screen 91 shown in FIG. 9 at the time of registering the project data), based on the billing information contained in the data supplied in step S34. In the event that judgment is made in step S38 that the project data is free of charge, the processing proceeds to step S44.

In the event that judgment is made in step S38 that the project data is pay data, in step S39 the billing settlement data processing unit 42 executes billing calculation processing described later with reference to FIG. 12. Then, in step S40, the billing settlement data processing unit 42 outputs an estimated amount calculated in step S39 to the communication processing unit 31 via the internal bus 32, and the communication processing unit 31 transmits signals indicating the estimated amount to the terminal device 12 of the user 2 via the Internet 22.

In step S41, the management center management processing unit 34 judges whether or not the user 2 has agreed to the estimated amount transmitted in step S40, based on the signal transmitted to the terminal device 12 of the user 2 via the Internet 22 and input via the communication processing unit 31.

In the event that judgment is made in step S41 that the user 2 has not agreed to the estimated amount, in step S42 the management center management processing unit 34 generates signals requesting the creator of the project data (i.e., the user 2) to either cancel the registration, or redo the settings, and outputs the signals to the communication processing unit 31. The communication processing unit 31 transmits signals requesting cancellation of registration or redoing of the settings to the terminal 12 of the user 2 via the Internet 22, and the processing ends.

In the event that judgment is made in step S41 that the user 2 has agreed to the estimated amount, in step S43 the management center management processing unit 34 generates signals indicating that the estimated amount has been agreed to, and outputs the signals to the billing settlement data processing unit 42. The billing settlement data processing unit 42 records the estimated amount as the payment amount to the user 2 in the event that the project data is purchased by another user, along with the project ID of corresponding project data for example, to the billing settlement database 43, along with the sale price set in the sale price setting text box in the setting screen 91 shown in FIG. 9.

In the event that judgment is made in step S38 that the project data is not pay data (i.e., the data is free of charge), or at the point of completion of the registration processing to the billing settlement database 43 in step S42, in step S44 the audio data processing unit 40 generates signals inquiring about the encoding settings of the input project data, and outputs the signals to the distribution settings data processing unit 39. The distribution settings data processing unit 39 makes reference to the distribution settings database 33-3 and generates signals indicating a reply to the inquiry, and outputs the signals to the audio data processing unit 40. The audio data processing unit 40 receives input of these signals, and judges whether or not encoding to project data is instructed or not.

In the event that judgment is made in step S44 that encoding is instructed, in step S45 the audio data processing unit 40 encodes the project data with the instructed format.

In the event that judgment is made in step S44 that encoding is not instructed, in step S46 the audio data processing unit 40 registers the project data as unconverted data (i.e., data wherein the track contents may be changed) and registers this to the distribution data storage group 41.

Following the processing in step S45 or step S46, in step S47 the audio data processing unit 40 subjects the project data to format conversion to distribution data, and stores this in the corresponding database 41-1 through 41-n in the distribution data storage group 41.

In step S48, the audio data processing unit 40 generates signals inquiring whether or not stereo distribution is desired for the input project data (i.e., whether or not the user 2 has checked the check box 94 in the settings screen 91 shown in FIG. 9 at the time of registering the project data), and outputs the signals to the distribution settings data processing unit 39. The distribution settings data processing unit 39 makes reference to the distribution settings database 33-3 and generates signals indicating a reply to the inquiry, and outputs the signals to the audio data processing unit 40. The audio data processing unit 40 receives input of the signals, and judges whether or not stereo distribution is desired for the project data. In the event that judgment is made in step S48 that stereo distribution is not desired for the input project data, the processing ends.

In the event that judgment is made in step S48 that stereo distribution is desired for the input project data, in step S49 the audio data processing unit 40 mixes down the project data, generates stereo data described with reference to FIG. 5, performs encoding according to a predetermined method, performs format conversion on the distribution data in step S50, and stores the data in the stereo data database 41-4 of the in the distribution data storage group 41, thus ending the processing.

Next, description will be made regarding the billing calculation processing in step S39 of FIG. 11, with reference to the flowchart shown in FIG. 12.

In step S71, the management center management processing unit 34 outputs billing information and copyright information contained in the data transmitted from the terminal device 12 of the user 2 via the Internet 22, to the billing settlement data processing unit 42. At this time, the billing settlement data processing unit 42 reads in the billing information and copyright information of the project data.

In step S72, the billing settlement data processing unit 42 subtracts the copyright management fee per piece decided by the copyright protection group 26 and the management fee for the management center 1 from the sale price of the project data contained in the billing information.

In step S73, the billing settlement data processing unit 42 judges whether or not a distribution rate has been decided upon beforehand between multiple copyright holders contained in the project data, from the distribution rate data contained in the billing information.

In the event that judgment is made in step S73 that a distribution rate has been decided upon beforehand, in step S76 the billing settlement data processing unit 42 calculates the estimated price from the calculation results in step S72 and the distribution rate. Subsequently, the processing proceeds to step S40 in FIG. 11.

In the event that judgment is made in step S73 that a distribution rate has not been decided upon, in step S74 the billing settlement data processing unit 42 searches the copyright holders of the tracks contained in the project data, and in step S75, the calculation results from step S72 are divided by a predetermined numerical value of either the number of copyright holders of the tracks contained in the project data or the number of tracks, thereby calculating the estimated price paid to the user 2. Subsequently, the processing proceeds to step S40 in FIG. 11.

Next, with reference to the flowchart in FIG. 13, description will be made regarding the music piece data selling processing in the case of the management center 1 selling music piece data to the users 2 through 5 under the contract formats 1 through 4. Here, description will be made regarding an example wherein the user 3 uses the terminal device 13 to purchase music piece data from the management center 1.

In the event of one of the users 2 through 4 purchasing data registered to the management center 1, not only can project data be purchased as such, of course, but also in the event that multiple tracks of data are contained in a set of project data, individual tracks of data can be purchased, and also stereo data may be purchased as well. Accordingly, in the subsequent description, this data will be collectively referred to as “music piece data”, which can mean any of the formats of project data, track data, and stereo data.

In step S81, the communication processing unit 31 receives access request from the user 3 via the Internet 22, i.e., input of the ID and password from the terminal device 13. The communication processing unit 31 outputs the input ID and password to the verification processing control unit 35.

In step S82, the verification processing control unit 35 queries the customer information database 33-1 regarding the input ID and password, and judgment is made whether or not the input ID and password are correct. In the event that judgment is made in step S82 that either one or both of the input ID and password are not correct, the flow proceeds to step S90.

In the event that judgment is made in step S82 that the input ID and password are correct, in step S83 the verification processing control unit 35 outputs signals to the management center management processing unit 34 indicating that the input ID and password are correct. The management center management processing unit 34 reads out the data of a Web page corresponding to the music piece data purchasing screen from the Web page storage database 36, and outputs this data to the communication processing unit 31. The communication processing unit 31 transmits the data of the Web page corresponding to the music piece data purchasing screen to the terminal device 13 via the Internet 22, for display on the output unit 67 of the terminal device 13.

In step S84, the communication processing unit 31 receives input of signals indicating the music piece data selected by the user 3 for purchase, via the Internet 22, and outputs the signals to the management center management processing unit 34.

In step S85, the management center management processing unit 34 generates control signals for calculating the charge for the music piece data selected by the user 3 for purchase input in step S84, and outputs the signals to the billing settlement data processing unit 42. The billing settlement data processing unit 42 makes reference to the billing settlement database 43 and calculates the charges for the music piece data, and outputs the charges to the management center management processing unit 34. The management center management processing unit 34 reads out from the Web page storage database 36 data corresponding to a Web page having an input form whereby the input charges for the music piece data are displayed and input can be made regarding confirmation of purchase, selection of payment method, ID corresponding to payment method (e.g., credit card No.), and so forth, and the management center management processing unit 34 transmits the data corresponding to this Web page to the communication processing unit 31. The communication processing unit 31 transmits this data to the terminal device 13 via the Internet 22, thereby displaying the Web page on the output unit 67 of the terminal device 13.

In step S86, the management center management processing unit 34 judges whether or not the desired payment method and corresponding ID and the like have been input from the terminal device 13, via the Internet 22, communication processing unit 31, and internal bus 32. In the event that judgment is made in step S86 that the desired payment method and corresponding ID and the like have not been input, the flow proceeds to step S90.

In the event that judgment is made in step S86 that the desired payment method and corresponding ID and the like have been input, in step S87 the management center management processing unit 34 generates control signals for making query of the input ID and the like at the settlement agency connection processing unit 44 with one of the settlement agencies 23 through 25 corresponding to the input payment method, and outputs the control signals. The settlement agency connection processing unit 44 generates signals for making query of the input ID and the like, and transmits the signals to one of the settlement agencies 23 through 25 corresponding to the input desired payment method, via the financial agency network 45.

In step S88, the settlement agency connection processing unit 44 receives reply to the query regarding the ID and the like from the one of the settlement agencies 23 through 25 corresponding to the input desired payment method, and based on this, judgment is made whether or not the settlement agency has guaranteed payment by the user 3 or not. In the event that payment by the user 3 has not been guaranteed in step S88, the flow proceeds to step S90.

In step S90, the management center management processing unit 34 reads out data corresponding to an error message from the Web page storage database 36, and outputs this to the communication processing unit 31. The communication processing unit 31 transmits the error message to the terminal device 13 via the Internet 22, and displays the error message on the output unit 67 of the terminal device 13, thereby ending processing.

In the event that-payment by the user 3 has been guaranteed in step S88, the settlement agency connection processing unit 44 outputs in step S89 signals indicating that payment by the user 3 has been guaranteed, to the management center management processing unit 34 and the billing settlement data processing unit 42 via the internal bus 32. The billing settlement data processing unit 42 records in the billing settlement database 43 the ID of the user 3, the amount purchased, the payment method, and the ID corresponding to the payment method.

The management center management processing unit 34 transmits permission to download the music piece data regarding which purchasing is desired to the terminal device 13 via the communication processing unit 31 and Internet 22, searches the music piece data which the user 3 desires as input in step S84 from the distribution data storage group 41, generates control signals for transmitting to the terminal device 13 via the internal bus 32, communication processing unit 31, and Internet 22, and outputs the control signals to the audio data processing unit 40. The audio data processing unit 40 searches the music piece data which the user 3 desires from the distribution data storage group 41, and transmits the music piece data to the terminal device 13 via the internal bus 32, communication processing unit 31, and Internet 22, thereby ending processing.

Also, a user which has entered into contract with the management center 1 can received services called “community” (i.e., participating in a community, which is a virtual space within the management center 1) by taking predetermined procedures. The community will be described with reference to FIG. 14.

Terminal devices 111 through 115 used by users 101 through 105 are actually connected to the management center 1 via the Internet 22, but the Internet 22 is omitted in FIG. 14. Also, the terminal devices 111 through 115 have the same configuration as the terminal device 12 described above with reference to FIG. 3, so description thereof will be omitted.

Community A and community B are protected by unique IDs and passwords for participating in the respective communities, the IDs and passwords being different from the IDs and passwords necessary for sharing the data of the management center 1. That is to say, a community may mean a group made up of multiple members having a particular common goal and objectives, and also may mean a virtual place formed by that group. In other words, a community is a virtual cyber-gathering or a space formed on the network in which only verified users having the unique ID and password can participate.

The members making up the group in the community are not an undetermined number of individuals who know nothing of one another, but are members who mutually recognize and trust one another. In other words, members making up a community are fellows. Other members, e.g., an undetermined number of members not verified by the administrator of the community, cannot participate in the community.

The community is not simply a venue for communication between members, but is provided as a virtual cyberspace to serve as a venue for multiple members to cooperatively create contents such as music pieces, a venue whereby multiple members can cooperatively participate in activities of creating contents such as music pieces, and a venue for creating new contents and information by using, arranging, or modifying contents and other information registered to the community.

A user applies for participation in the contents to the community administrator for example, and can only participate in the community of interest in the event that an ID and password unique to that community has been issued. In the example shown in FIG. 14, the user 101 and the user 102 can participate in community A but not in community B, and in the same way the user 105 can participate in community B but not in community A. However, in the event that access rights to both community A and community B have been obtained as with user 103 and use 104, and IDs and passwords unique to both communities have been issued, the users can participate in both communities.

The members belonging to the respective communities can cooperatively create music piece data, can cooperatively create and register contents, and can share the registered contents. That is, arrangements may be made wherein each of the members participating in the community is appropriated with an instrument or vocal part, and each member uploads his/her track data, thereby creating one set of music data, or wherein track data uploaded to the community is partially changed, or project data made up from multiple tracks is re-mixed. Thus, a community can even take an orchestra score for a great number of instruments, with community participants creating track data for each part appropriated thereto at their own homes, and each uploading the data to the community, where a mixer technician within the community will download and mix down the uploaded track data, thereby generating stereo data for even an orchestra.

The members participating in the community can download and upload data at will, whether the data be all contents, project data contained in the contents, or track data or stereo data contained in the project data, in arbitrary units.

Also, arrangements may be made wherein the community A and community B can allow members participating in the communities to download tools necessary for creating the contents or tools necessary for changing the data of the contents being created in each of the communities, separately for each community.

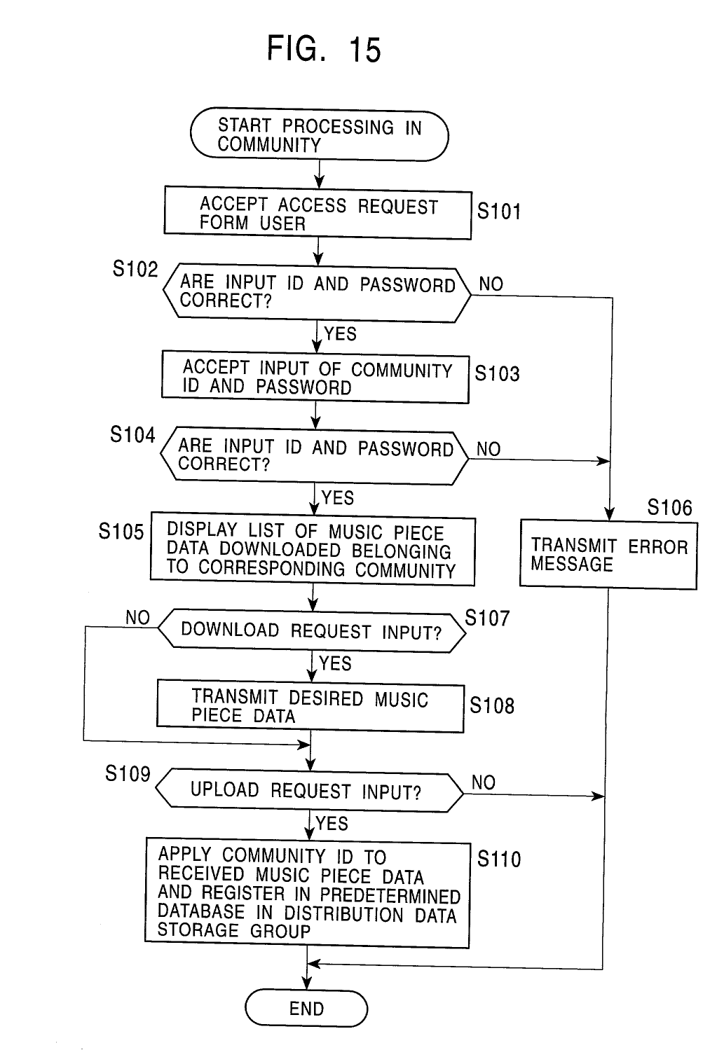

Next, processing in the community will be described with reference to the flowchart shown in FIG. 15. Here, the processing at the management center 1 will be described, with regard to an example wherein download of music data registered in the community A is requested from a user 101 registered to the community A using the communication processing device 111, and registration of new music data is requested to the community A.

In step S101, the communication processing unit 31 receives input of the access request to the management center 1 from the user 101 via the Internet 22, i.e., the ID and password from the terminal device 111 (the ID and password for obtaining permission to access the management center 1). The communication processing unit 31 outputs the input ID and password to the verification processing control unit 35 In step S102, the verification processing control unit 35 makes query to the customer information database 33-1 regarding the input ID and password, and judgment is made whether or not the input ID and password are correct. In the event that judgment is made in step S102 that either one or both of the input ID and password are not correct, the flow proceeds to step S106.

In the event that judgment is made in step S102 that the input ID and password are correct, in step S103 the communication processing unit 31 receives input of the access request to the community A from the user 101 via the Internet 22, i.e., the ID and password from the terminal device 111 (the ID and password for obtaining permission to access the community A). The communication processing unit 31 outputs the input ID and password to the verification processing control unit 35 In step S104, the verification processing control unit 35 makes query to the customer information database 33-1 regarding the input ID and password, and judgment is made whether or not the input ID and password are correct. In the event that judgment is made in step S104 that either one or both of the input ID and password are not correct, the flow proceeds to step S106.

In step S106, the management center management processing unit 34 reads out data corresponding to an error message form the Web page storage database 36, and outputs this to the communication processing unit 31. The communication processing unit 31 transmits the error message to the terminal device 111 via the Internet 22, and displays the error message on the output unit 67 of the terminal device 111, thereby ending processing.

In the event that judgment is made in step S104 that the input ID and password are correct, the management center management processing unit 34 causes the audio data processing unit 40 to search for music piece data having the community ID of the community A from data recorded in the distribution data storage group 41, and generates and outputs control signals for outputting the project name thereof for example to the management center management processing unit 34. Further, the management center management processing unit 34 reads out a format of a Web page for displaying a list of downloadable music pieces, from the Web page storage database 36. The audio data processing unit 40 searches the music piece data having the community ID of the community A, and outputs to the management center management processing unit 34 the project name and the like, for example. The management center management processing unit 34 generates a Web page listing the music price data registered to the community A, and transmits this to the terminal device 111 via the communication processing unit 31 and the Internet 22.

In step S107, the management center management processing unit 34 judges whether or not a download request for desired music piece data has been input from the terminal device 111, via the Internet 22, communication processing unit 31, and internal bus 32. In step S107, in the event that judgment is made that a download request for music piece data has not been input, the flow proceeds to step S109.

In the event that judgment is made in step S107 that a download request for music piece data has be(n input, in step S108 the management center management processing unit 34 causes the audio data processing unit 40 to search the music piece data which the user 101 desires from the distribution data storage group 41, and generates and outputs control signals for transmitting to the terminal device 111 via the internal bus 32, communication processing unit 31, and Internet 22. The audio data processing unit 40 searches the music piece data which the user 101 desires from the distribution data storage group 41, and transmits the music piece data to the terminal device 111 via the internal bus 32, communication processing unit 31, and the Internet 22.

In step S109, the management center management processing unit 34 judges whether or not an upload request for music piece data has been input from the terminal device 111, via the Internet 22, communication processing unit 31, and internal bus 32. In step S109, in the event that judgment is made that an upload request for music piece data has not been input, the flow ends.

In the event that judgment is made in step S109 that an upload request has been input, in step S110 the management center management processing unit 34 subjects the music piece data transmitted from the terminal device 111 via the Internet 22, communication processing unit 31, and internal bus 32, to encoding and format conversion as described with reference to FIGS. 10 and 11 for example, and registers the data to a predetermined database in the distribution data storage group 41, with the community ID attached thereto, thereby ending processing.

In this way, a community ID is added at the time of registering music piece data to a predetermined database of the distribution data storage group 41, so users not participating in the community cannot download data registered to the community, and also in the above-described step S105, downloadable music price data belonging to the corresponding community can be search and a list can be displayed.

The above series of processing has been described with reference to a case wherein the management center 1 handles music data, but it is needless to say that contents indicating information other than music data can be handled as well.

The above series of processing can also be realized by software. A program comprising such software is installed from a recording medium to a computer to which is assembled dedicated hardware, or for example to a general-purpose personal computer which is capable of executing various function by installing various types of programs.

This recording medium comprises packaged media of magnetic disks 51 or 71 (including floppy disks), optical disks 52 or 72 (including CD-ROMs (Compact Disk Read-Only Memory) and DVDs (Digital Versatile Disk)), magneto optical disks 53 or 73 (including MDs (Mini-Disk)), semiconductor memory 54 or 74, or the like, with programs recorded thereupon, distributed separately from the computer for providing programs to users, as shown in FIGS. 2 and 3.

Also, the present invention includes processing wherein the steps in the specification describing the program recording on the recording medium are carried out in time sequence in the described order, but also includes processing wherein the processing is not necessarily carried out in time-sequence, with the processing being executed in parallel or independently, as well.

Further, in the present specification, the term “system” is to be understood to refer to the overall equipment configured of multiple devices.

With the information processing device and information processing method according to the first and second aspects, music data made up from multiple tracks is held, copyright information is added for each track, and music data made up from multiple tracks to which copyright information is added is registered to another information processing device capable of distributing the music data by individual tracks, so music data made up for multiple tracks to which copyright information has been added and information set by information setting control means is transmitted via a network, and accordingly, music data made up of multiple tracks can be registered in a state with copyright information added for each track, and the music data can be distributed by individual tracks.

With the information processing device and information processing method according to the third and fourth aspects, music data made up from multiple tracks is held, copyright information is added for each track, and music data made up from multiple tracks to which copyright information is added is registered to another information processing device capable of distributing the music data by individual, the other information processing device being controlled so that only predetermined users verified beforehand can perform registering and distribution of the music data, so music data made up for multiple tracks to which copyright information has been added and information set by information setting control means is transmitted via a network, and accordingly, contents data made up of multiple tracks can be registered in a state with copyright information added for each track, and the music data can be distributed by individual tracks.

With the information processing device and information processing method according to the fifth and sixth aspects, contents data transmitted via a network and copyright information set to the contents data is received, the contents data is subjected to encoding processing, the contents data subjected to encoding processing is saved, and copyright usage fees for the contents data are calculated based on the copyright information, and accordingly, registered contents data made up of multiple tracks can be distributed by individual tracks in a state with copyright information added for each track.

With the information processing device and information processing method according to the seventh and eighth aspects, contents data transmitted via a network and copyright information set to the contents data is received, and copyright usage fees for the contents data are calculated based on the copyright information, and accordingly, registered contents data made up of multiple tracks can be distributed by individual tracks in a state with copyright information added for each track.

With the information processing device, information processing method, and program stored in the recording medium, according to the ninth through eleventh aspects, the holding of music data made up of multiple tracks is controlled, reception of signals representing transmission requests for the music data from other information processing devices via a network is controlled, the music data held by the processing in the holding step is searched for based on the signals of which reception is controlled, and the music data searched by the processing in the searching step is controlled by track.

With the information processing device and information processing method according to the twelfth and thirteenth aspects, multiple members in a predetermined mutual relationship provide a virtual community for activities of cooperatively creating contents to a network, access rights to the community are verified in the event that the information processing device is accessed by the other information processing devices via the network, and services relating to activities of creating the contents are provided to other information processing devices via the network, based on the verification results.

Also, with the information processing device and information processing method according to the fourteenth and fifteenth aspects, contents provided from multiple members are registered to a virtual community for the multiple members to perform activities of cooperatively creating contents, access rights to the community are verified in the event that the information processing device is accessed by the other information processing devices via the network, and the contents registered to the community are provided to other information processing devices via the network, based on the verification results.

Also, with other aspects of the present invention, music pieces made up of multiple instrument/vocal parts are created, copyright information is added to each of the multiple instrument/vocal parts, and the music pieces made up of the instrument/vocal parts with copyright information added to each of the instrument/vocal parts are registered to a management center or a community so that other users can use the music pieces.

Also, contents created by a user and copyright information relating to the contents are received via a network, the contents are encoded following the copyright information, the encoded contents are stored in a server for distribution, and copyright usage fees relating to the contents are set, based on the copyright information.

Also, billing fees are settled in the case of others using the contents, based on the copyright information.

Also, music pieces created by a user and multiple sets of copyright information set to each of the instrument/vocal parts making up the music piece are received via a network, audio signals corresponding to the multiple instrument/vocal parts are encoded according to the multiple sets of copyright information, the encoded audio signals are stored in a distributing server for each of the multiple instrument/vocal parts, and copyright usage fees relating to the music piece are settled, based on the multiple sets of copyright information.

Also, a virtual community is provided upon a network for multiple members belonging to a group to participate in cooperatively creating contents or creating new contents using contents provided from the multiple members, accesses to the community via the network are verified, and services relating to activities of creating the contents are provided to verified members via the network.

Also, a virtual community is provided upon a network, original contents are registered thereto, access rights are verified for users making access requests via the network, verified users are provided with contents registered in the community and services for arranging or modifying the contents to create new contents, and the contents are provided to verified users via the network.

What is claimed is:

1. An information processing device comprising:
holding means for holding music data made up of a plurality of tracks;
adding means for adding copyright information to each of said tracks;
information setting control means for controlling the setting of necessary information, for registering with another information processing device capable of distributing by individual track said music data made up of a plurality of tracks to which are added copyright information by said adding means; and
transmission control means for controlling transmission via a network, of said music data made up of a plurality of tracks to which are added copyright information by said adding means and said information set by said information setting control means.

2. An information processing method comprising:
a holding step for holding music data made up of a plurality of tracks;
an adding step for adding copyright information to each of said tracks;
an information setting control step for controlling the setting of necessary information, for registering with another information processing device capable of distributing by individual track said music data made up of a plurality of tracks to which are added copyright information by the processing in said adding step; and
a transmission control step for controlling transmission via a network, of said music data made up of a plurality of tracks to which are added copyright information in said adding step and said information set by the processing in said information setting control step.

3. An information processing device comprising:
holding means for holding music data made up of a plurality of tracks;
adding means for adding copyright information to each of said tracks;
information setting control means for controlling the setting of necessary information, for registering with another information processing device capable of distributing by individual track said music data made up of a plurality of tracks to which are added copyright information by said adding means, said another information processing device controlled so that only predetermined users verified beforehand can perform registering and distribution of said music data; and
transmission control means for controlling transmission via a network, of said music data made up of a plurality of tracks to which are added copyright information by said adding means and said information set by said information setting control means.

4. An information processing method comprising:
a holding step for holding music data made up of a plurality of tracks;
an adding step for adding copyright information to each of said tracks;
an information setting control step for controlling the setting of necessary information, for registering with another information processing device capable of distributing by individual track said music data made up of a plurality of tracks to which are added copyright information by the processing in said adding step, said another information processing device controlled so that only predetermined users verified beforehand can perform registering and distribution of said music data; and
a transmission control step for controlling transmission via a network, of said music data made up of a plurality of tracks to which are added copyright information by the processing in said adding step and said information set by the processing in said information setting control step.

5. An information processing device comprising:
reception control means for controlling reception of contents data transmitted via a network and copyright information set to said contents data;
encoding processing means for performing encoding processing of said contents data regarding which reception has been controlled by said reception control means;
saving control means for controlling saving of said contents data subjected to encoding processing by said encoding processing means; and
calculating means for calculating copyright usage fees for said contents data, based on said copyright information.

6. An information processing device according to claim 5, wherein said contents data is music data, made up of a plurality of tracks, and wherein said copyright information is set for each of said plurality of tracks.

7. An information processing method comprising:
a reception control step for controlling reception of contents data transmitted via a network and copyright information set to said contents data;
an encoding processing step for performing encoding processing of said contents data regarding which reception has been controlled in said reception control step;
a saving control step for controlling saving of said contents data subjected to encoding processing in said encoding processing step; and
a calculating step for calculating copyright usage fees for said contents data, based on said copyright information.

8. An information processing device comprising:
reception control means for controlling reception of contents data transmitted via a network and copyright information set to said contents data; and
calculating means for calculating billing fees at the time of using said contents data, based on said copyright information.

9. An information processing device according to claim 8, further comprising:
encoding processing means for performing encoding processing of said contents data regarding which reception has been controlled by said reception control means; and
saving control means for controlling saving of said contents data subjected to encoding processing by said encoding processing means.

10. An information processing device according to claim 8, wherein said contents data is music data, made up of a plurality of tracks, and wherein said copyright information is set for each of said plurality of tracks.

11. An information processing method comprising:
a reception control step for controlling reception of contents data transmitted via a network and copyright information set to said contents data; and
a calculating step for calculating billing fees at the time of using said contents data, based on said copyright information.

12. An information processing device comprising:
holding means for holding music data made up of a plurality of tracks;
reception control means for controlling reception of signals representing transmission request for said music data from other information processing devices via a network;
searching means for searching for said music data held by said holding means, based on said signals of which reception is controlled by said reception control means; and
first transmission control means for controlling transmission of said music data searched by said searching means, by each of the plurality of said tracks.

13. An information processing device according to claim 12, wherein copyright information is set to each of the plurality of said tracks.

14. An information processing device according to claim 13, further comprising:
calculating means for calculating usage fees for said music data based on said copyright information; and
second transmission control means for controlling transmission of data corresponding to the usage fees of said music data calculated by said calculating means, with regard to said other information processing device of which transmission of said music data has been controlled by said first transmission control means.

15. An information processing method comprising:
a holding control step for controlling the holding of music data made up of a plurality of tracks;
a reception control step for controlling reception of signals representing transmission request for said music data from other information processing devices via a network;
a searching step for searching for said music data held in said holding step, based on said signals of which reception is controlled by the processing in said reception control step; and
a first transmission control step for controlling transmission of said music data searched by the processing in said searching step, by each of the plurality of said tracks.

16. A recording medium recording a computer-readable program, said program comprising:
a holding control step for controlling the holding of music data made up of a plurality of tracks;
a reception control step for controlling reception of signals representing transmission request for said music data from other information processing devices via a network;
a searching step for searching for said music data held by the processing in said holding step, based on said signals of which reception is controlled by the processing in said reception control step; and
a first transmission control step for controlling transmission of said music data searched by the processing in said searching step, by each of the plurality of said tracks.

17. An information processing device connected to other information processing devices via a network, said device comprising:
first providing means for a plurality of members to provide a virtual community for activities of cooperatively creating contents to said network;
verifying means for performing verification processing of access rights to said community in the event that said information processing device is accessed by said other information processing devices via said network; and
second providing means for providing services relating to activities of creating said contents to said other information processing devices via said network, based on the verification results of said verifying means.

18. An information processing device according to claim 17, wherein said second providing means register contents provided from said plurality of members to said community.

19. An information processing device according to claim 18, wherein said second providing means provide said contents registered to said community to other members.

20. An information processing device according to claim 19, wherein said second providing means further registers to said community contents created based on said contents registered to said community and provided from said plurality of members.

21. An information processing device according to claim 18, wherein said first providing means issue IDs to users of said other information processing devices.

22. An information processing device according to claim 21, wherein said second providing means registers said contents in a manner corresponding to said IDs, so that the creators of said contents can be identified.

23. An information processing method of an information processing device connected to other information processing devices via a network, said device comprising:
a first providing step for a plurality of members in a predetermined mutual relationship to provide a virtual community for activities of cooperatively creating contents to said network;
a verifying step for performing verification processing of access rights to said community in the event that said information processing device is accessed by said other information processing devices via said network; and
a second providing step for providing services relating to activities of creating said contents to said other information processing devices via said network, based on the verification results by the processing in said verifying step.

24. An information processing device connected to other information processing devices via a network, said device comprising:
registering means for registering contents provided from a plurality of members to a virtual community for said plurality of members to perform activities of cooperatively creating contents;
verifying means for performing verification processing of access rights to said community in the event that said information processing device is accessed by said other information processing devices via said network; and
providing means for providing said contents registered to said community to said other information processing devices via said network, based on the verification results of said verifying means.

25. An information processing device according to claim 24, wherein said providing means further register to said community contents created by modifying or arranging said contents registered to said community and provided from said plurality of members.

26. An information processing device according to claim 25, wherein said providing means further provide to other information processing devices contents created by modifying or arranging said contents registered to said community and further registered to said community.

27. An information processing method for an information processing device connected to other information processing devices via a network, said method comprising:
a registering step for registering contents provided from a plurality of members to a virtual community for said plurality of members to perform activities of cooperatively creating contents;
a verifying step for performing verification processing of access rights to said community in the event that said information processing device is accessed by said other information processing devices via said network; and
a providing step for providing said contents registered to said community to said other information processing devices via said network, based on the verification results by the processing in said verifying step.

28. A music piece distributing system comprising:
means for creating music pieces made up of a plurality of instrument/vocal parts;
means for adding copyright information to each of said plurality of instrument/vocal parts;
means for transferring, via a network, music pieces made up of said plurality of instrument/vocal parts to which said copyright information has been added; and
means for registering said music pieces to a management center for management thereof so that other users can use said music pieces by individual instrument/vocal parts.

29. A music piece distributing system comprising:
means for creating music pieces made up of a plurality of instrument/vocal parts;
means for adding copyright information to each of said plurality of instrument/vocal parts; and
means for registering to a community provided upon a network, said music pieces made up of said instrument/vocal parts with copyright information added to each of said instrument/vocal parts, so that other users can use said music pieces by each of said plurality of instrument/vocal parts.

30. A contents distributing system comprising:
means for receiving contents created by a user and copyright information relating to said contents, via a network;
means for encoding said contents following said copyright information;
means for storing said encoded contents in a server for distributing said contents; and
means for settling copyright usage fees relating to said contents, based on said copyright information.

31. A contents distributing system comprising:
means for receiving contents created by a user and copyright information set to said contents, via a network;
means for storing said contents in a distributing server connected to said network; and
means for setting billing fees in the case of others using said contents, based on said copyright information.

32. A music piece distributing system comprising:
means for receiving, via a network, music pieces created by a user, and a plurality of sets of copyright information set to each of a plurality of instrument/vocal parts making up said music piece;
means for encoding audio signals corresponding to said a plurality of instrument/vocal parts, according to said plurality of sets of copyright information;
means for storing said encoded audio signals to a distributing server for each of said plurality of instrument/vocal parts; and
means for settling copyright usage fees relating to said music piece, based on said plurality of sets of copyright information.

33. A music piece distributing system comprising:
means for receiving music pieces created by a user, and a plurality of sets of copyright information set to a plurality of instrument/vocal parts making up said music piece;
means for storing said music piece in a distributing server connected to said network, by each instrument/vocal part; and
means for setting billing fees in the case of others using said music piece, based on said plurality of sets of copyright information.

34. A service providing method comprising:
a step for a plurality of members, belonging to a group made up of members having mutual relationships, to provide a virtual community for performing activities of cooperatively creating contents upon a network;
a step for performing verification processing of access rights to said community in the event that there has been an access request via said network; and
a step for providing services relating to activities of creating said contents to said verified members via said network.

35. A service providing method comprising:
a step for providing upon a network a virtual community for performing creating activities of cooperatively creating new contents using contents provided from a plurality of members belonging to a group made up of members having mutual relationships;
a step for verifying, in the event that there has been an access request from a user via said network, whether or not said user is a member having access rights to said community; and
a step for providing services relating to activities of creating said contents to said verified member via said network.

36. A service providing method comprising:
a step for a plurality of members, belonging to a group made up of predetermined members, to provide a virtual community for performing creating activities of cooperatively creating contents upon a network;
a step for performing verification processing of access rights to said community in the event that there has been an access request via said network; and
a step for providing services relating to activities of creating said contents to said verified members via said network.

37. A service providing method comprising:
a step for providing upon a network a virtual community for a plurality of members belonging to a group made up of predetermined members to participate in creating activities of cooperatively creating new contents using contents provided from said plurality of members;
a step for verifying, in the event that there has been an access request from a user via said network, whether or not said user is a member having access rights to said community; and
a step for providing services relating to activities of creating said contents to said verified member via said network.

38. A service providing method comprising:
a step for providing a virtual community on a network;
a step for registering original contents to said community;
a step for verifying, in the event that there has been an access request from a user via said network, whether or not said user is a member having access rights to said community; and
a step for providing to said verified user, services for creating new contents by modifying or arranging original contents provided to said community, via said network.

39. A service providing method comprising:
a step for registering original contents to a virtual community provided on a network;
a step for performing verification processing regarding access rights to said community, for users making access requests via said network;
a step for providing to said verified users, services for modifying or arranging original contents provided to said community and creating new contents, via said network; and
a step for distributing said contents to said verified users via said network.

40. A service providing method comprising:
a step for performing verification processing regarding access rights to a virtual community provided on a network, for users making access requests via said network; and
a step for providing to said verified users, contents registered in said community, and services for arranging or modifying said contents, via said network.
